(19) United States
(12) Patent Application Publication
(10) Pub. No.: US 2013/0013450 A1
(43) Pub. Date: Jan. 10, 2013

(54) E-COMMERCE CONTENT MANAGEMENT SYSTEM FOR DYNAMIC VENDOR SUBSTITUTION

(76) Inventor: MARK SEARS, RIVERSIDE, CA (US)

(21) Appl. No.: 13/544,966

(22) Filed: Jul. 9, 2012

Related U.S. Application Data
(60) Provisional application No. 61/505,953, filed on Jul. 8, 2011.

(51) Int. Cl. G06Q 30/06

(52) U.S. Cl. 705/26.8

(57) ABSTRACT

An e-commerce content management system generates at least one Website that permits configuration of the Website for dealer self-routing, user directed vendor substitution, destination routing and dynamic vendor substitution routing. The e-commerce content management system allows a user to configure the system, including a Website, such as configuring a dealer Website as part of an ecosystem that includes an alliance of dealers, manufacturers, shippers and other participants that fill orders. The ecosystem integrates orders processed through a business process management kernel operating on one or more computers.

### RELATED APPLICATION

This application claims the benefit, under 35 USC §119, of U.S. Provisional Application No. 61/505,953, filed on Jul. 8, 2011 and entitled “Computer-Aided Workflow Using Scenario-Biased Order Routing”, which is hereby incorporated by reference herein in its entirety.

### FIELD OF THE INVENTION

The present invention relates generally to data processing in content management systems, more specifically to computer-aided workflow management.

### BACKGROUND OF THE INVENTION

The growth of consumer/customer demand for choices and configurability in products and services has far outstripped the capabilities of individual product or service suppliers to provide all choices in all configurations to all prospective customers. And the appearance of, and capability to manufacture and deliver, highly-configurable or customer-ized products has become commonplace in certain product and service areas. For example, the availability of highly-configurable products based on custom printing has exploded. Today, using a website interface, a consumer may customize virtually any article of manufacture with a printed or embroidered, or otherwise affixed design, and such a design may be wholly defined by the consumer. Extending this model to cover a wide range of articles of manufacture introduces myriad possibilities for bringing manufacturers into an ecosystem of dealers, manufacturers, artwork vendors, printers, assemblers, inspectors, and shippers for the provisioning of products to customers. Traditional techniques for managing the flow from customer requirements to customer satisfaction with the delivered product or service rely substantially on human interaction to set up workflow parameters, and also often rely on human interaction to set up a workflow for each job. Yet, in a commercial ecosystem of (for example) hundreds of dealers, thousands of manufacturers, thousands of artwork vendors, printers, assemblers, inspectors, and scores of shippers, it becomes difficult and expensive to manage the huge number of possible workflows. Various mathematical techniques have been proposed for enumerating possible workflows within a particular (static) ecosystem, yet such mathematical techniques fall short when considering the dynamic nature of a real-world ecosystem where the characteristics of a consumer-specified product, and where the characteristics of the ecosystem participants, may (and do) change minute by minute on the basis of human decisions.

Accordingly, there exists a need for overcoming the abovementioned and other limitations in order to facilitate a computer-aided workflow with operator-biased order routing.

### BRIEF DESCRIPTION OF THE DRAWINGS

The novel features of the invention are set forth in the appended claims. However, for purpose of explanation, several embodiments of the invention are set forth in the following figures:

FIG. 1A depicts components of a content management system, according to one embodiment.

FIG. 1B depicts components of a content management system, according to one embodiment.

FIG. 2A depicts participants within an ordering and fulfillment ecosystem for processing an order for a customized article, according to one embodiment.

FIG. 2B depicts participants within an ordering and fulfillment ecosystem for processing an order for a customized article, including a web presence participant, according to one embodiment.

FIG. 2C depicts participants within an ordering and fulfillment ecosystem for processing an order for a customized article, including a web presence participant, which is itself serving as a vendor, according to one embodiment.

FIG. 2D depicts participants within an ordering and fulfillment ecosystem for processing an order for a customized article, including a web presence participant, according to one embodiment.

FIG. 2E depicts participants within an ordering and fulfillment ecosystem for processing an order for a customized article, including a web presence participant, according to one embodiment.

FIG. 3 depicts components of an ecosystem for processing an order for a customized article, according to one embodiment.

FIG. 4A depicts a web presence web page from a website as produced by a content management system showing orderable product options, according to one embodiment.

FIG. 4B depicts a web presence web page from a website as produced by a content management system showing customization options, according to one embodiment.

FIG. 4C depicts a web presence web page from a website as produced by a content management system showing template options, according to one embodiment.

FIG. 4D depicts a web presence web page from a website as produced by a content management system showing mailing options, according to one embodiment.

FIG. 4E depicts a web presence web page from a website as produced by a content management system showing routing options, according to one embodiment.

FIG. 4F depicts a web presence web page from a website as produced by a content management system showing interactive vendor set-up, according to one embodiment.

FIG. 4G depicts a web presence web page from a website as produced by a content management system showing dealer self routing options, according to one embodiment.

FIG. 4H depicts a web presence web page from a website as produced by a content management system showing vendor substitution routing options, according to one embodiment.

FIG. 5 depicts a schematic of an e-commerce system showing workflows from receipt of an order through delivery to a final fulfillment point, according to one embodiment.

FIG. 6A depicts an exemplary data structure of an order description, according to one embodiment.

FIG. 6B depicts an exemplary data structure of a workflow, according to one embodiment.

FIG. 6C depicts an exemplary data structure of an entity description, according to one embodiment.

FIG. 7A depicts an exemplary workflow showing passing of forwarding data and order data between entities, according to one embodiment.

FIG. 7B depicts an exemplary workflow showing passing of forwarding data and order data from an entity to a web presence participant, according to one embodiment.

FIG. 8A depicts a web presence web page from a website as produced by a content management system showing order splitting options, according to one embodiment.

FIG. 8B depicts a web presence web page from a website as produced by a content management system showing location-based routing options using an order destination location, according to one embodiment.

FIG. 8C depicts a web presence web page from a website as produced by a content management system showing location-based routing options using a vendor site location, according to one embodiment.

FIG. 8D depicts a web presence web page from a website as produced by a content management system showing pricing adjustments in a shopping cart summary, according to one embodiment.

FIG. 9 depicts a protocol for implementing a computer-aided workflow with operator-biased order routing, according to one embodiment.

FIG. 10 depicts a system for implementing a computer-aided workflow, according to one embodiment.

FIG. 11 is a diagrammatic representation of a network, according to one embodiment.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order to not obscure the description of the invention with unnecessary detail.

### Definitions

Some of the terms used in this description are defined below (in alphabetical order) for easy reference. These terms are not rigidly restricted to these definitions; instead, a term is defined by the full scope of plain meaning and lexicography disclosed herein. A term may be further defined by its use in other sections of this description.

“Advertising” refers to marketing a product and/or service to one or more potential consumers by using an ad. One example of advertising is publishing a sponsored search ad on a website.

“Alliance” refers to a group of manufacturers and/or service providers that enter into a contractual agreement to manufacture products in accordance with specific guidelines.

“Application Server” is a server that is configured for running one or more devices loaded on the application server.

“Automated Clearing House (ACH)” refers to a method used for dealer to pay another entity and vice versa for transaction charges.

“Call Center” (Optional) is a service for providing a customized professional call center support program.

“Pay Flow Account” refers to a merchant account to cover transaction charges as defined above.

“Click” (e.g. ad click) refers to a selection of an ad impression by using a selection device such as, for example, a computer mouse or a touch-sensitive display.

“Client” refers to the client part of a client-server architecture. A client is typically a user device and/or an application that runs on a user device. A client typically relies on a server to perform some operations. For example, an email client is an application that enables a user to send and receive email via an email server. In this example, the computer running such an email client may also be referred to as a client.

“Database” (e.g. database system, etc) refers to a collection of data organized in such a way that a computer program may quickly select desired pieces of the data. A database is an electronic filing system. In some instances, the term “database” is used as shorthand for a “database management system”. A database may be implemented as any type of data storage structure capable of providing for the retrieval and storage of a variety of data types. For instance, a database may include one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

“Dealer” refers to an entity that licenses software (e.g. a content management system) for creating and managing a web presence for itself, substitute vendors and members of the alliance.

“Dealer Pay Flow Account” refers to a Merchant Account held by a Dealer to cover transacnon charges as defined above. Dealers who have their own pay flow account will agree to allow an Automated Clearing House (ACH) transactions for the payment of all fees owed.

“Dealer Pay Out” refers to the amount of money sent to a dealer based on sales minus applicable processing charges and/or dealer routing.

“Dealer Routing Fees” refers to fees charged for branded website orders as well as alliance routed, self routed and/or substitute vendor routed orders. These fees are adjustable on a per site basis.

“Device” refers to hardware, software or a combination thereof. A device may sometimes be referred to as an apparatus. Examples of a device include, without limitation, a software application such as Microsoft Word™ or a database; or hardware such as a laptop computer, a server, a display; or a computer mouse and/or a hard disk.

“Manufacturer” refers to a vendor capable of manufacturing an orderable article or a component of an orderable article.

“Master Dealer” refers to a dealer or entity that enters into a contractual agreement to sell branded website technology to other dealers of the trade for purposes of selling products manufactured by alliance members.

“Module” refers to a function, implemented using at least one processor and memory, the memory to store software instructions.

“Network” refers to a connection, between any two or more computers, that permits the transmission of data. A network may be any combination of networks including, without limitation, the internet, a local area network, a wide area network, a wireless network, and/or a cellular network.

“Order” refers to a codification of a transaction, for example, “Order five hundred each of CAT#12345 paper weights with the image ‘emblemjpg’ engraved using the ‘Engraving-E3’ process.”

“Order Routing Fees” refers to an amount charged for special handling of an order involving routing within a workflow.

“Server” refers to a software application that provides services to other computer programs (and their users) on the same computer or on another computer or computers. A server may also refer to the physical computer that has been set aside to run a specific server application. For example, when the software Apache HTTP Server is used as the web server for a company's website, the computer running Apache may also be called the web server. Server applications may be divided among server computers over an extreme range, depending upon the workload.

“Software” refers to a computer program that is written in a programming language that may be used by one of ordinary skill in the art. The programming language chosen should be compatible with the computer on which the software application is to be executed and, in particular, with the operating system of that computer. Examples of suitable programming languages include, without limitation, Object Pascal, C, C++ and/or Java. Further, the functions of some embodiments, when described as a series of steps for a method, could be implemented as a series of software instructions for being operated by a processor such that the embodiments could be implemented as software, hardware, or a combination thereof. Computer-readable media are discussed in more detail in a separate section below.

“System” refers to a device or multiple coupled devices. A device is defined above.

“User Device” (e.g. computer, user computer, client and/or server, etc) refers to a single computer or a network of interacting computers. A user device is a computer that a user may use to communicate with other devices over a network, such as the internet. A user device is a combination of a hardware system, a software operating system, and perhaps one or more software application programs. Examples of a user device include, without limitation, a laptop computer, a palmtop computer, a smart phone, a cell phone, a mobile phone, an IBM-type personal computer (PC) having an operating system such as Microsoft Windows™, an Apple™ computer having an operating system such as MAC-OS, hardware having a JAVA-OS operating system, and/or a Sun Microsystems™ workstation having a UNIX operating system.

“Vendor” refers to an entity for providing performance of a service (e.g. delivery service, an inspection service, etc) or production of a manufacturing operation (e.g. printing, engraving, etc) or delivery of information (e.g. a logo vendor, a website hosting operator, etc). A vendor may operate in the alliance or a vendor (e.g., substitute vendor) may operate outside the alliance. Examples of vendors include printing corporations, print brokers, ad agencies, graphic designers, textile providers, mailing houses, etc.

“Web Browser” refers to a software program that may display text or graphics or both, from web pages on websites. Examples of a web browser include, without limitation, Mozilla Firefox™ and Microsoft Internet Explorer™.

“Web Page” refers to documents written in a mark-up language including, without limitation, HTML (hypertext mark-up language), VRML (virtual reality modeling language), dynamic HTML, XML (extensible mark-up language), and/or other related computer languages. A web page may also refer to a collection of such documents reachable through one specific internet address and/or through one specific website. A web page may also refer to any document obtainable through a particular URL (uniform resource locator).

“Web Portal” (e.g. public portal) refers to a website or service that offers a broad array of resources and services such as, for example, email, forums, search engines, and online shopping malls. The first web portals were online services, such as AOL, that provided access to the web. However, now, most of the traditional search engines have transformed themselves into web portals to attract and keep a larger audience.

“Web Server” is a server configured for serving at least one web page to a web browser. A server is defined above.

“Website” refers to one or more web pages. A website preferably includes a plurality of web pages virtually connected by links or URL addresses to form a coherent group.

“Workflow” refers to a sequence of steps and any routing of materials or information to accomplish the steps so as to define and fulfill an order. Also, “Workflow” refers to a traversal of goods and information through a path (e.g. routes), for performing operations on the goods or information intended to result in a fulfillment on an order. The operations may be subject to constraints.

An E-Commerce Content Management System for Generating A Website and Processing Orders within An E-Commerce Ecosystem.

An e-commerce content management system generates at least one Website that permits configuration of the Website for dealer self-routing. Specifically, the e-commerce content management system allows a user to configure the Website as a dealer Website as part of an ecosystem that includes an alliance of dealers, manufacturers, shippers and other participants that fill orders. The ecosystem integrates orders processed through a business process management kernel operating on one or more computers. To generate the dealer Website, the e-commerce content management system receives input, from a user setting up the dealer Website, to configure the dealer Website to offer for sale at least a portion of products or services fulfilled by the dealer and one or more members of the alliance. The e-commerce content management system also receives input to configure the dealer Website, for run time operation, for at least one product or service, to select another member of the alliance to fulfill orders of the product or service. During runtime, the orders of the product or service are routed through the business process management kernel to the other member of the alliance for fulfillment. In addition, the e-commerce content management system receives input to configure the dealer Website, for run time operation, for at least one product or service, to select fulfillment of orders of the product or service through the dealer. In this case, the orders of the product or service are routed through the business process management kernel to the dealer.

During runtime operation of the dealer Website, the dealer Website receives input, from a consumer computer, to select for purchase at least one of the products or services. The business process management kernel generates an order for the product or service, and determines whether to route the order to the dealer or a member of the alliance based on the previous configuration. As such, the business process management kernel routes at least a portion of the order to the dealer if the dealer is configured as the vendor to fulfill the order, and routes at least a portion of the order to the member of the alliance if the dealer is not configured as the vendor to fulfill the order.

An e-commerce content management system generates at least one Website that permits configuration of the Website for user directed vendor substitution. Specifically, the e-commerce content management system allows a user to configure the Website as a dealer Website as part of an ecosystem that includes an alliance of dealers, manufacturers, shippers and other participants that fill orders. In addition, the e-commerce content management system allows a user to configure the Website to include other vendors, outside the alliance, as part of the ecosystem. The ecosystem integrates orders processed through a business process management kernel operating on one or more computers. To generate the dealer Website, the e-commerce content management system receives input, from a user setting up the dealer Website, to configure the dealer Website to offer for sale at least a portion of products or services and to designate, for fulfillment, either a vendor outside the alliance (e.g., substitute vendor) or one or more members of the alliance. During runtime, the orders of the product or service are routed through the business process management kernel to either the substitute vendor or a member of the alliance for fulfillment, based on the configuration.

During runtime operation of the dealer Website configured for user directed vendor substitution, the dealer Website receives input, from a consumer computer, to select for purchase at least one of the products or services. The business process management kernel generates an order for the product or service, and determines whether to route the order to a substitute vendor or a member of the alliance based on the previous configuration. As such, the business process management kernel routes at least a portion of the order to the substitute vendor if the substitute vendor is configured as the vendor to fulfill the order, and routes at least a portion of the order to one or more members of the alliance if the system is configured to select one or more members of the alliance as the vendor to fulfill the order.

An e-commerce content management system generates at least one Website that permits configuration of the Website for destination routing. Specifically, the e-commerce content management system allows a user to configure the Website (Web Presence Participant) as part of an ecosystem that includes an alliance of dealers, manufacturers, shippers and other participants that fill orders. The ecosystem integrates orders processed through a business process management kernel operating on one or more computers. To generate the Web Presence Participant Website, the e-commerce content management system receives input, from a user setting up the Website, to configure the Website to offer for sale at least a portion of products or services for fulfillment by a member of the alliance based on a proximity between geographic locations of the member of the alliance and a destination for the order. During runtime, the orders of the product or service are routed through the business process management kernel to members of the alliance for fulfillment based on proximity between geographic locations of the member of the alliance and a destination for the order.

During runtime operation of the Website configured for destination routing, the Website receives input, from a consumer computer, to select for purchase at least one of the products or services. The business process management kernel generates an order for the product or service, and determines where to route the order based on the geographic proximity.

An e-commerce content management system generates at least one Website that permits configuration of the Website for dynamic vendor substitution in order routing. Specifically, the e-commerce content management system allows a user to configure the Website (Web Presence Participant) as part of an ecosystem that includes an alliance of dealers, manufacturers, shippers and other participants that fill orders. The ecosystem integrates orders processed through a business process management kernel operating on one or more computers. To generate the Web Presence Participant Website, the e-commerce content management system receives input to configure the Website to offer for sale at least a portion of products or services for fulfillment by a member of the alliance. The business process management kernel is configured, for at least one product or service, to initiate a first-routing of an order to a selected member of the alliance. In addition, the business process management kernel is configured to determine, at a time after the first-routing, whether the member of the alliance selected can fulfill the order. If the member of the alliance selected can't fulfill the order, then the business process management kernel initiates a second-routing of the order to a different member of the alliance.

During runtime operation of the business process management kernel configured for dynamic vendor substitution in order routing, the Website receives input, from a consumer computer, to select for purchase at least one of the products or services. The business process management kernel generates an order for the product or service, and initiates the first-routing. Thereafter, if at a time after the first-routing the selected member of the alliance can't fulfill the order, then the business process management kernel initiates a second-routing of the order to a different member of the alliance.

Computer-Aided Workflow with Operator-Biased Order Routing

Internet commerce is facilitated through use of a graphical user interface (GUI) of a content management system. Through human-computer interaction (e.g. using a GUI), the human user may establish certain aspects of the internet commerce (e.g. characteristics of an order, characteristics of a transaction, routing, etc). Through such interactions, any one or more orders or transactions may be described by the user, analyzed by the computer, confirmed and/or further described by the human, and at least some of the operations attendant to the performance of the workflow for achieving the user-specified transaction may be accomplished by the computer. Some embodiments described herein are specifically configured to perform order routing operations, and such order routing operations may operate from a complex (sometimes extremely complex) network of nodes. Further, performance of order routing operations in response to real-time changes may result in still an even more complicated network of nodes. As the complexity of the network of nodes increases, so do the possibilities for workflows (including routes). In some cases as the network of nodes increases, the possibilities for workflows increases exponentially.

Content Management Systems Used to Implement a Computer-Aided Workflow with Operator-Biased Order Routing

As earlier indicated, performance of internet commerce is facilitated through use of a graphical user interface (GUI) to a computer, and such a graphical user interface may be implemented by (or using) a web content management system (WCMS), which is a software system that provides website authoring, collaboration and administration tools designed to allow automated creation and management of a web site.

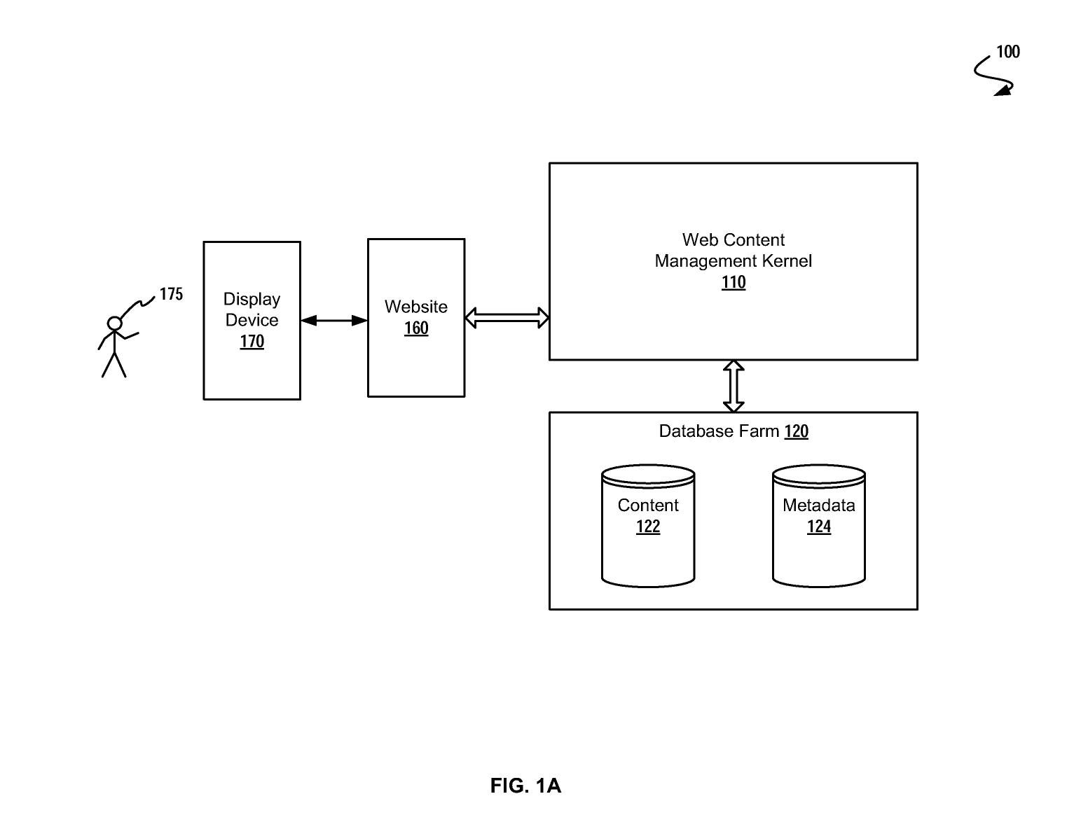

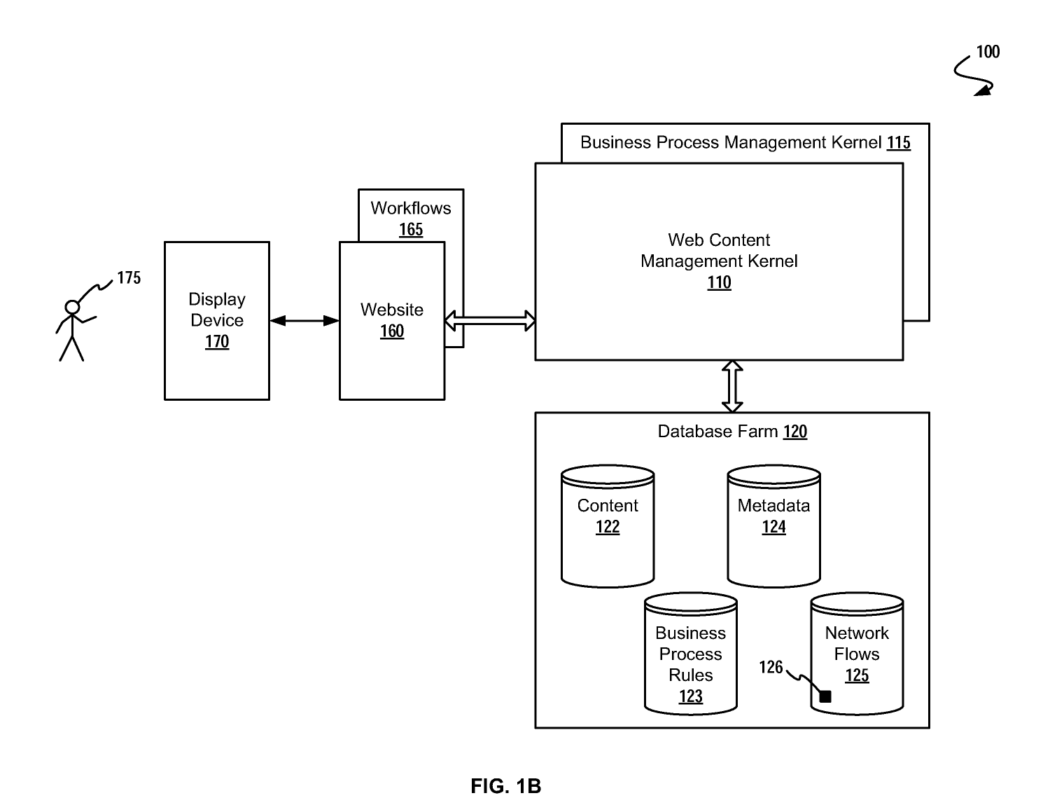

FIG. 1A depicts components of a content management system, according to one embodiment. Some embodiments of a content management system 100 include a web content management kernel 110 connected to a database farm 120, the database farm in turn including one or more instances of a content database 122 to store content, a metadata database 124 for storing any content (e.g. lists, tables, descriptive text, images, etc), and formats (e.g. styles, templates) or objects (e.g. links, traversal hierarchy, keyword taxonomy, etc) that might be needed by the system. In some embodiments, the content and/or metadata and/or objects may be stored as XML. A presentation layer (not shown) displays the content to a website user. The content may be presented to the user in a structured manner, possibly using a series of web pages (e.g. within website 160), which web pages are designed to be formatted for display on a display device 170 to a website user 175. The particular formatting characteristics may be captured in metadata (e.g. XSLT, HTML) and/or may be based on one or more templates stored in any convenient representation.

Some WCMS implementations such as the ones discussed herein allow non-technical users to make changes to a website with little or no training In fact, some of the more sophisticated WCMS implementations discussed herein are constructed so as to be intuitive to a wide range of target users. Moreover, some of the more sophisticated WCMS implementations discussed herein are adaptive to the user's interface, and often include computer-aided techniques so as to facilitate intuitive operation by even a casual user.

Discussed herein are three major operational modes of WCMS: offline processing, online processing, and hybrid systems. These terms describe the deployment pattern for the WCMS in terms of when presentation templates are applied to render web pages from structured content. Certain WCMS systems, operating in online processing mode, apply templates on demand. HTML may be generated when a user visits the page, or may be pulled from a cache.

Further, some WCMS systems have the capability to support add-ons, which provide extended capabilities including forums, blogs, wikis, web stores, photo galleries, contact management, etc. These are often called widgets, add-ons or extensions.

FIG. 1B depicts components of a content management system, according to one embodiment. Some embodiments of a content management system 100 include a business process management kernel 115 connected to a database farm 120, the database farm in turn including one or more instances of a business process rules database 123 for storing rules and heuristics, and a network flows database 125 for storing one or more instances of a network flow graph 126 that might be needed by the system for business process management. In some embodiments, the data in the database farm 120 may be stored as XML.

As described in the embodiment of FIG. 1A, a presentation layer displays certain content to a website user 175. The content may be presented to the user in a structured manner, possibly using a series of web pages (e.g. within website 160), which web pages are designed to be formatted for display on a display device 170. Moreover, the business process management kernel 115 may produce a network flow graph 126 possibly including workflows, which workflows 165 may be displayed, partially or in their entirety (or not at all) together with a web page within website 160.

The business process management kernel serves various management functions, including (but not limited to) search and selection of workflows; capabilities and authorizations for order creating and ongoing order-related collaboration; transaction records management; workflow management; and coordination with any web content management system. In exemplary embodiments, the business process management kernel serves for managing the lifecycle of information from initial order creation, through fulfillment, and even to archival and disposal of information. The business process management kernel may deliver services using one or more of at least these application deployment techniques:
On-premise software: Installed on the user's or organization's own network.
Software as a Service (SaaS): Web access to information that is provided by (i.e. stored, and operates from) a system other the user's or organization's own network).
Rich-client/hybrid solution: May be composed of both on-premise and SaaS components.

Such systems as described in FIG. 1A and FIG. 1B may be used within a commercial ecosystem of commercial entities (e.g. customers, manufacturers, dealers, servicers, vendors, etc) for cradle-to-grave order management (e.g. article selection, order entry, article manufacture/customization, delivery, disposal, etc).

Roles of Participants in a System for Computer-Aided Workflow with Operator-Biased Order Routing

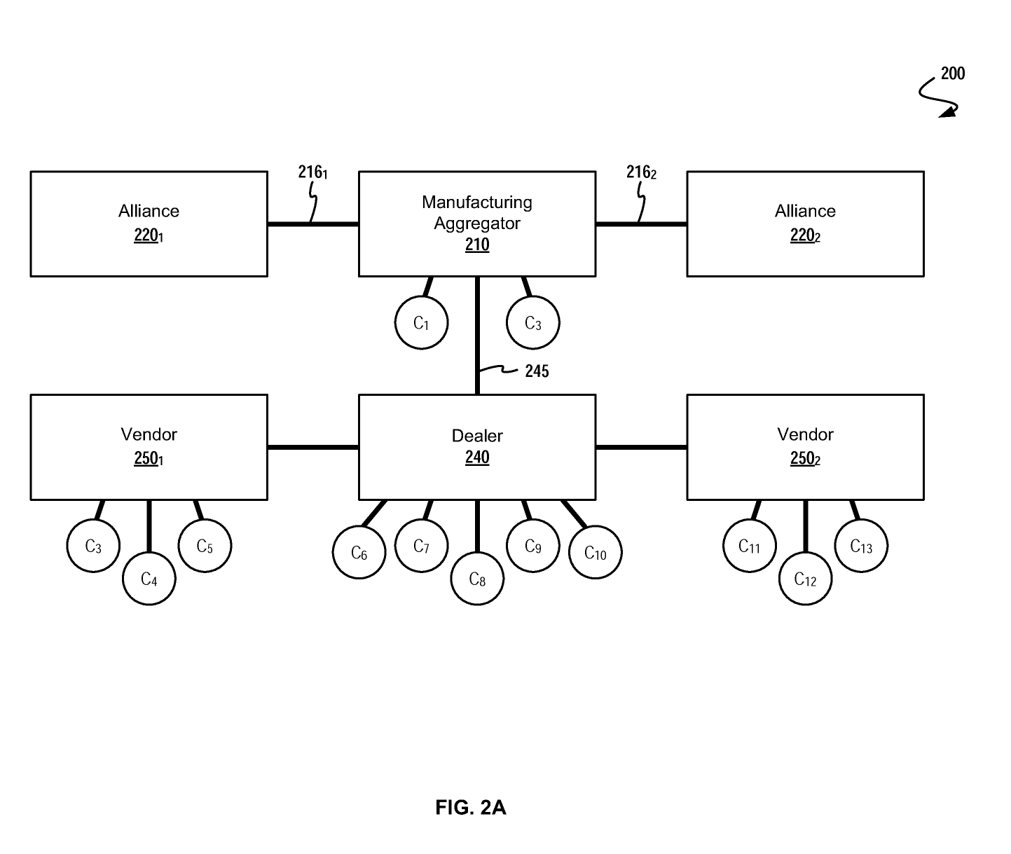

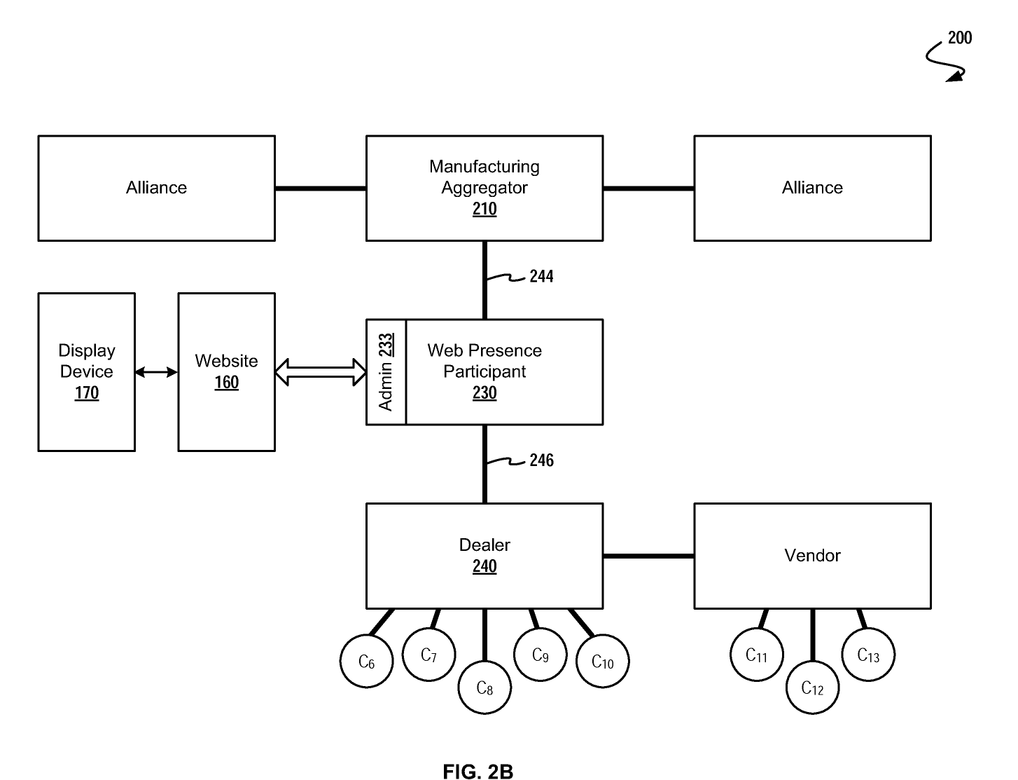

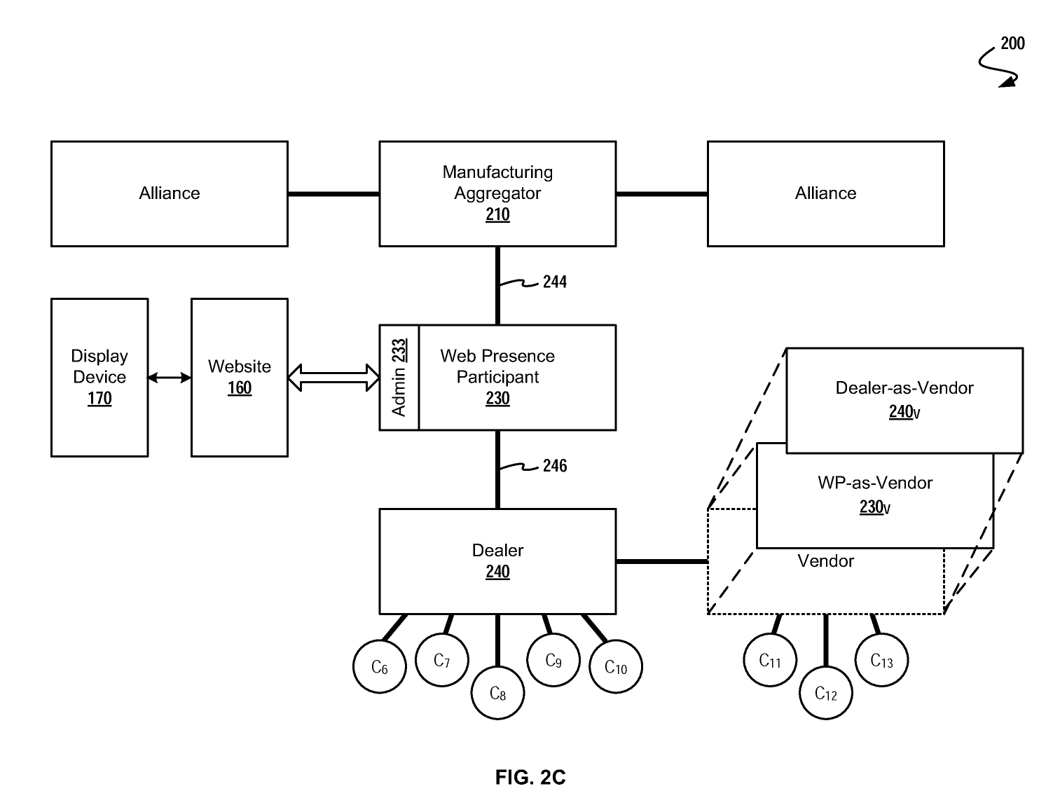

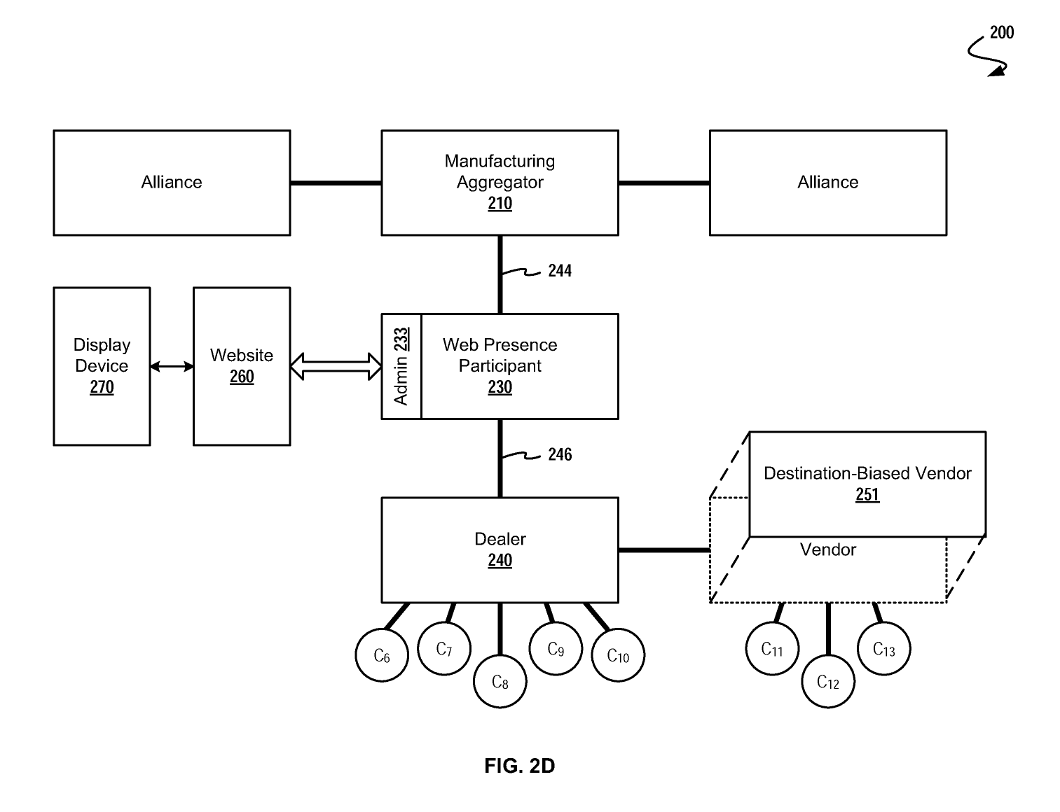

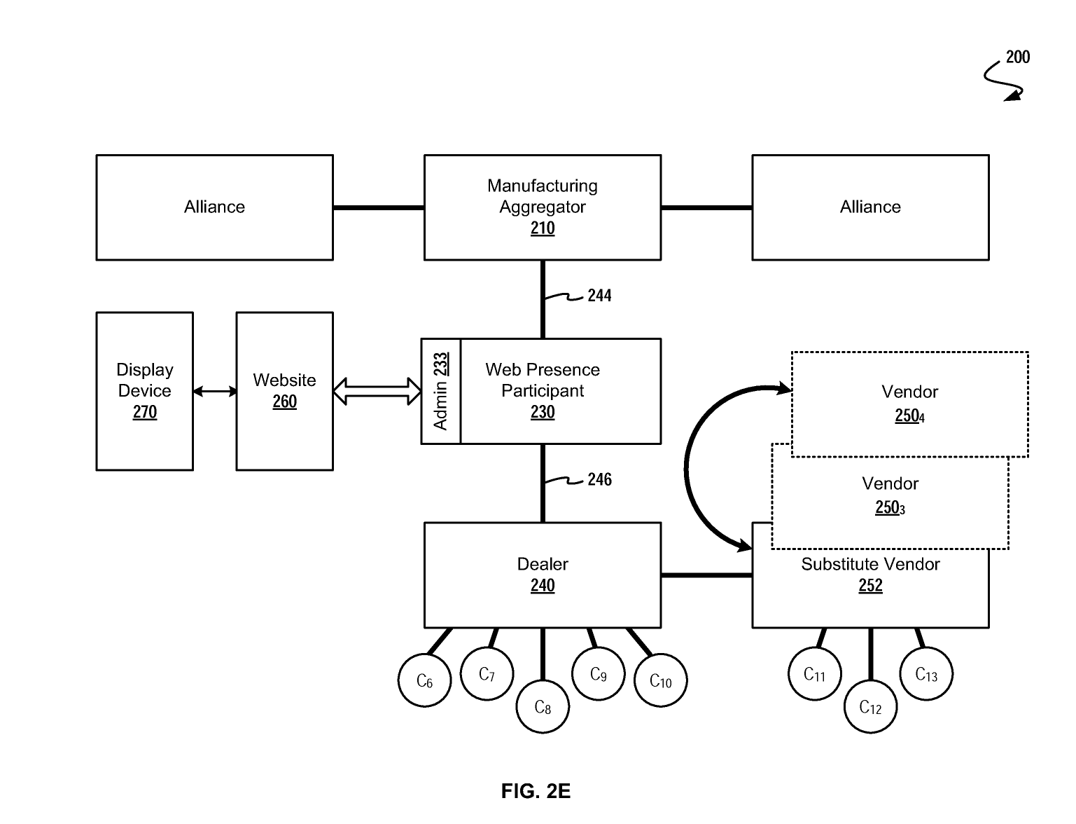

FIG. 2A depicts participants within an ordering and fulfillment ecosystem for processing an order for a customized article. As shown, the ordering and fulfillment ecosystem 200 includes a dealer 240 having a plurality of customers. In this embodiment, the dealer 240 may receive orders for goods or services (or information) and fulfill the orders to customers C₆, C₇, C₈, C₉, C₁₀, etc. In some cases a dealer 240 may involve one or more vendors for fulfilling orders and/or customizing orders. For example, a dealer might operate a trade pertaining to say, customized t-shirts, whereby the dealer may source plain white t-shirts from vendor 250₁, and may source artwork (e.g. logos, emblems, etc) for imaging on the t-shirt from a different vendor, namely vendor 250₂. Thus, the dealer, having received an order from a customer for a customized t-shirt may also fulfill the order, arranging for shipment of the completed order to the customer. Of course the aforementioned article (goods) of a t-shirt is purely exemplary, and any other article of manufacture may be considered as the goods. Moreover, aspects of customization or an article are myriad, and may include printing processes such as sheet feed printing, offset printing, digital printing, large format printing, grand format printing, etc.

In some situations, a dealer might involve a vendor for receiving orders. As per the previous example, a dealer might operate a trade pertaining to say, customized t-shirts, yet the dealer may involve a vendor to receive an order from a customer. As a specific example of this situation, a dealer might involve an online major league baseball (MLB) ticket vendor (e.g. TicketMaster, Sport-Tickets-R-Us, etc) to receive an order from a customer, in this case a t-shirt bearing a licensed logo pertaining to major league baseball. The order, having been taken by the ticket vendor, may then be transmitted to the dealer, and the dealer may in turn use its network of vendors to fulfill the order and ship to the customer. In fact, a similar situation is shown in FIG. 2A. As shown, the dealer 240 may communicate over link 245 to an online storefront such as (and as shown) a manufacturing aggregator 210 (MA) and may involve the online storefront to receive the order from a customer. Continuing with the major league baseball example, if the dealer were to engage TicketMaster (shown as manufacturing aggregator 210), then TicketMaster may take an order from customer C₁, which order is communicated over link 245 to the dealer 240, which dealer in turn uses its network of vendors to fulfill the order and ship to the customer C₁.

In exemplary embodiments, a manufacturing aggregator 210 has an online presence, yet is an entity operated by real people in a business setting. Accordingly, a manufacturing aggregator 210 may involve any number of alliances (e.g. alliance 220₁, alliance 220₂), and may communicate with the alliance(s) over link 216₁ or link 216₂. In some cases, a manufacturing aggregator 210 may perform one or more operations involved in the path from order-to-order fulfillment, and may serve as a vendor to the dealer.

As may be readily understood, there are often many possible workflows from receiving an order to fulfilling an order, and a workflow may be described (an example of which is shown in Table 1) by a traversal through processes, where a given process is performed by a participant in the ecosystem.

TABLE 1
Possible workflow descriptions and traversals

| Workflow Description | Traversals |
|---|---|
| In-House Fulfillment | {C₆ (place order), |
| | dealer (in-house fulfillment of |
| | manufacturing & shipping), |
| | C₆ (receive order)} |
| Dealer's | {C₆, |
| Subcontract Out | dealer (subcontract out), |
| | vendor 250₂ (manufacture), |
| | C₆} |
| Online Storefront + | {C₁, |
| In-House | MA (receive order), |
| | dealer, |
| | C₁} |
| Online Storefront + | {C₁, |
| Subcontract Out | MA (receive order), |
| | dealer, |
| | vendor 250₂ (manufacturing), |
| | dealer (shipping), |
| | C₁} |
| Online Storefront + | {C₁, |
| Subcontract | MA (receive order), |
| Out + Drop Ship | dealer, |
| | vendor 250₂ (manufacturing and shipping), |
| | C₁} |
| Online Storefront + | {C₁, |
| Subcontract | MA (receive order), |
| Out + Drop Ship | dealer, |
| to Alternate Address | vendor 250₂ (manufacturing and shipping), |
| | C₂ (at request of C₁,} |

As may be seen from the traversals of Table 1, many possibilities exist for traversal from receipt of an order to order fulfillment. An order may be received at an initial entry point by any one of a plurality of participants, and an order may be manufactured by any (one or more) of participants, and an order may be shipped to a final fulfillment point by any (one or more) of participants capable of performing shipping.

FIG. 2B depicts participants within an ordering and fulfillment ecosystem for processing an order for a customized article, including a web presence participant. As shown, the ordering and fulfillment ecosystem 200 includes a dealer 240 having a plurality of customers. As in the embodiment shown and described in FIG. 2A, the dealer 240 may receive orders for goods or services (or information) and fulfill the orders to customers C₆, C₇, C₈, C₉, C₁₀, etc. In some cases a dealer 240 may participate in the ecosystem as a web presence participant 230, which web presence participant may be formed by combining the characteristics of a dealer 240 (e.g. operating as a franchisee) with a website 160, (e.g. where the website is branded under the terms of a franchising arrangement). And as shown, the dealer 240 may communicate over link 246 to an online storefront such as the web presence participant 230 (WP). Inasmuch as a web presence participant 230 is a particular case of an online storefront (e.g. an online storefront for a dealer), the web presence participant 230 may communicate over link 244 to a manufacturing aggregator 210. In fact, the web presence participant 230 may hold forth a web presence as a proxy for a dealer, or as a proxy for a manufacturing aggregator, or as a proxy for any participant within an ordering and fulfillment ecosystem. In exemplary cases, the web presence is provided in the form of a website 160, which website may be the output by modules of a web content management kernel 110. Any resulting website 160 may be administered by an admin 233, and/or an admin 233 may administer the web content management kernel 110 for configuring aspects of the web content management kernel that may, in turn, result in a correspondingly-configured website.

In this example (i.e. the web presence as a proxy for a dealer), the web presence participant attracts customers on behalf of the dealer, and takes orders on behalf of the dealer, thus, the web presence participant does not have customers of its own. Nevertheless, the WP may be deemed a participant in the ecosystem, and may be included in any traversals from order receipt to order fulfillment, an example of which is shown in Table 2.

TABLE 2
Possible workflow descriptions and
traversals including a web presence

| Workflow Description | Traversals |
|---|---|
| In-House Fulfillment (from | {C₆ (place order at WP), |
| initial order entry point to | WP (transmit order to dealer), |
| shipment to customer) | dealer (in-house fulfillment of |
| | manufacturing & shipping), |
| | C₆ (receive order)} |
| Dealer's | {C₆ (place order at WP), |
| Subcontract Out | WP (transmit order to dealer), |
| | dealer (subcontract out), |
| | vendor 250₂ (manufacture), |
| | C₆} |
| MA + In-House | {C₁ (place order at WP), |
| | WP (transmit order to MA), |
| | MA (receive order), |
| | dealer (fulfillment of |
| | manufacturing & shipping), |
| | C₁} |
| Online Storefront + | {C₁ (place order at WP), |
| Subcontract Out | WP (transmit order to MA), |
| | dealer, |
| | vendor 250₂ (manufacturing), |
| | dealer (shipping), |
| | C₁} |
| Online Storefront + | {C₁ (place order at WP), |
| Subcontract | WP (transmit order to MA), |
| Out + Drop Ship | MA (receive order), |
| | dealer, |
| | vendor 250₂ (manufacturing and shipping), |
| | C₁} |
| Online Storefront + | {C₁ (place order at WP), |
| Subcontract | WP (transmit order to MA), |
| Out + Drop Ship | MA (receive order), |
| to Alternate Address | dealer, |
| | vendor 250₂ (manufacturing and shipping), |
| | C₂ (at request of C₁,} |

As may be seen from the traversals of Table 2, many possibilities involving a WP exist for traversal from receipt of an order to order fulfillment.

Those skilled in the art may now recognize that the performance of commerce within the aforementioned ecosystem may be facilitated using computer-aided workflows (e.g. routes, operations).

More specifically, a web content management kernel 110 may be configured for generating a GUI (e.g. website 160) for display on a display device 170, in turn for receiving an order description. The order description may comprise a default workflow (for example, involving a selection of one or more of the customer's preferred vendors). Having an order description then, a module such as a business process management kernel 115 may be used for determining workflows (there may be many) of routes, operations and constraints such that the commercial characteristics of the order description are satisfied, and the order is delivered to the intended final fulfillment point. In exemplary cases, a user does not specify the entire workflow (in some cases the workflow is quite complex) and thus, a module such as a business process management kernel 115 may be used to enumerate (and validate) viable workflows. In this exemplary case, a web content management kernel 110 may produce a web page for rendering a list of possible workflows, and the user may suggest/select/confirm the user's preferred workflow. Thus, even though a given workflow may be complex, and even though the number of workflows may be large, a user may be provided the opportunity to influence the composition of workflows.

FIG. 2C depicts participants within an ordering and fulfillment ecosystem for processing an order for a customized article, including a web presence participant, which is itself serving as a vendor. As shown, the ordering and fulfillment ecosystem 200 includes a dealer 240 having a plurality of customers. As in the embodiment shown and described in FIG. 2A, the dealer 240 may receive orders for goods or services (or information) and fulfill the orders to customers. The dealer 240 may involve a web presence participant 230, which web presence participant may be a franchisee.

As pertaining to embodiments implementing a computer-aided workflow using dealer self-insertion in order routing, a dealer (or, more particularly, an admin acting on behalf of a dealer), may configure a web content management kernel 110, and/or may configure a business process management kernel 115 (or both) so as to perform order routing

FIG. 2D depicts participants within an ordering and fulfillment ecosystem for processing an order for a customized article, including a web presence participant. As shown, the ordering and fulfillment ecosystem 200 includes a dealer 240 having a plurality of customers. As in the embodiment shown and described in FIG. 2A, the dealer 240 may receive orders for goods or services (or information) and fulfill the orders to customers. The dealer 240 may involve a web presence participant 230, which web presence participant may be a franchisee. As pertaining to embodiments implementing a computer-aided workflow using user directed location-based vendor substitution in order routing, a dealer (or, more particularly, an admin acting on behalf of a dealer), may configure a web content management kernel 110, and/or may configure a business process management kernel 115 (or both) so as to perform order routing such that a user may bias a business process management kernel 115 for selecting one or more vendors based on the proximity to a geographic point. For example, a web content management kernel may produce a website that presents an option (i.e. using a GUI or web page widget) to select from among one or more vendors near to the customer's final destination point or at least within some specified proximity (e.g. a destination-biased vendor 251).

FIG. 2E depicts participants within an ordering and fulfillment ecosystem for processing an order for a customized article, including a web presence participant. As shown, the ordering and fulfillment ecosystem 200 includes a dealer 240 having a plurality of customers. As in the embodiment shown and described in FIG. 2A, the dealer 240 may receive orders for goods or services (or information) and fulfill the orders to customers. The dealer 240 may involve a web presence participant 230, which web presence participant may be a franchisee. As pertaining to embodiments implementing a computer-aided workflow using dynamic vendor substitution techniques in order routing, a dealer (or, more particularly, an admin 233 acting on behalf of a dealer), may configure a web content management kernel 110, and/or may configure a business process management kernel 115 (or both) so as to perform order routing such that a user may bias a business process management kernel 115 for substituting (i.e. swap-in) one or more vendors based on the current status of a vendor within a workflow. For example, using techniques described herein for a computer-aided workflow using user directed vendor substitution in order routing, a user may direct or bias workflow to a particular vendor based on user preferences. However, it may happen that the particular vendor selected may not be able to fulfill its portion of the order. For example, it might be that a user-preferred vendor was properly selected for some operation in a workflow, and at the time of the order, the vendor was able to perform, but at the time the order materials are to be routed to the user-preferred vendor, the vendor was unable to fulfill the order. This may happen for a multitude of reasons, including reasons of scheduling (i.e. the previous steps in the workflow were delayed), reasons of materiel (e.g. the user-preferred vendor ran out of stock in a needed component), or for other reasons (e.g. natural disaster, contract expirations, etc).

In such a case, embodiments for a computer-aided workflow using dynamic vendor substitution techniques in order routing may dynamically substitute in a different vendor—that is, a vendor that is able to perform the needed operations. Such a substitution may occur at any point in time when it becomes known that a user-preferred vendor is or will be unable to fulfill the order. Some embodiments provide for a data exchange protocol such that the substitution may occur without human involvement.

As shown, vendor 250₄ is swapped out in favor of substitute vendor 252. Of course, it may happen that a single vendor is substituted using mutiple vendors, or it may happen that two or more vendors are substituted (swapped-in) in lieu of a single vendor.

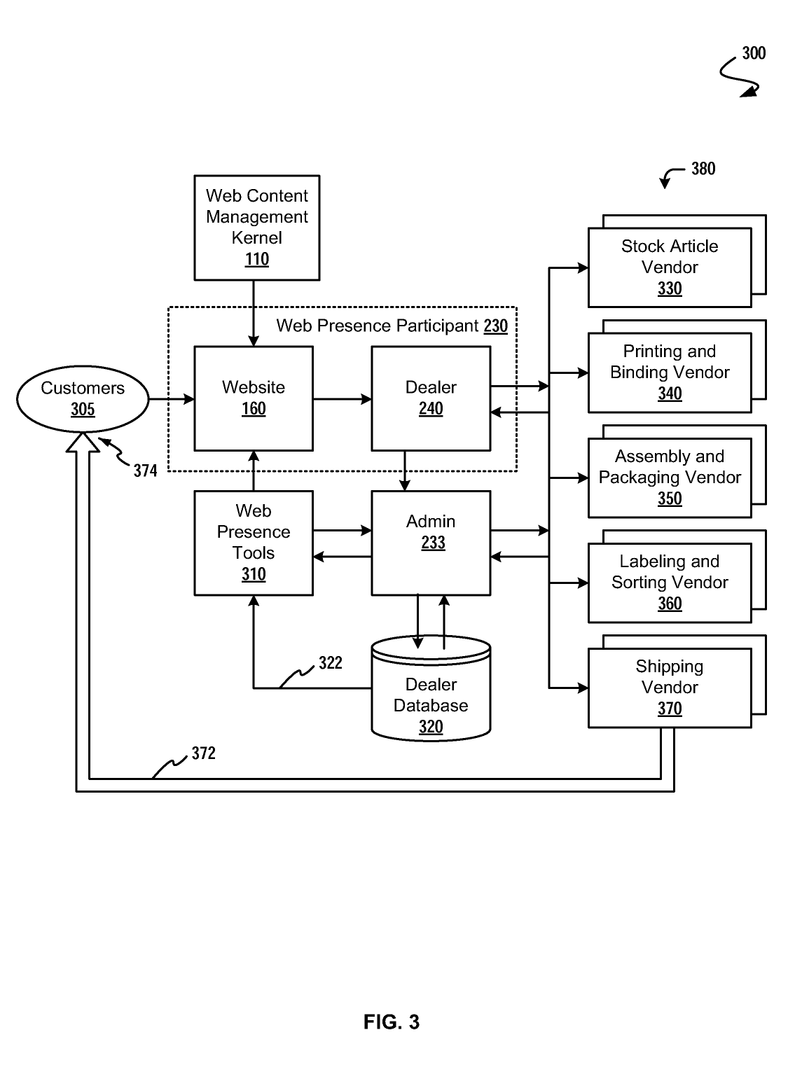

FIG. 3 depicts components of an ecosystem for processing an order for a customized article. As shown, commercial ecosystem 300 includes customers 305, which customers place orders using a website 160 (e.g. a website of a web presence participant 230), which orders in turn are provided to the dealer 240. The dealer maintains a dealer database 320, which dealer database serves for organizing a network of vendors. In exemplary operation, a dealer's admin (e.g. admin 233) may configure the website using web presence tools 310. For example, the website might display various customizable articles for purchase, which customizable articles may be produced using any one or more of the participants in the vendor network 380. In some cases, the admin 233 may access (e.g. for reading or writing) the dealer database 320 for making updates. Also, the admin 233 may input data items from the dealer database into the web presence tools or, in some cases, the admin 233 may assign a data conduit 322 from the dealer database into the web presence tools. For example, the dealer database may include data items in the form of an XML database, and the admin may assign (e.g. using web presence tools 310) a data conduit 322 referring to the aforementioned XML database.

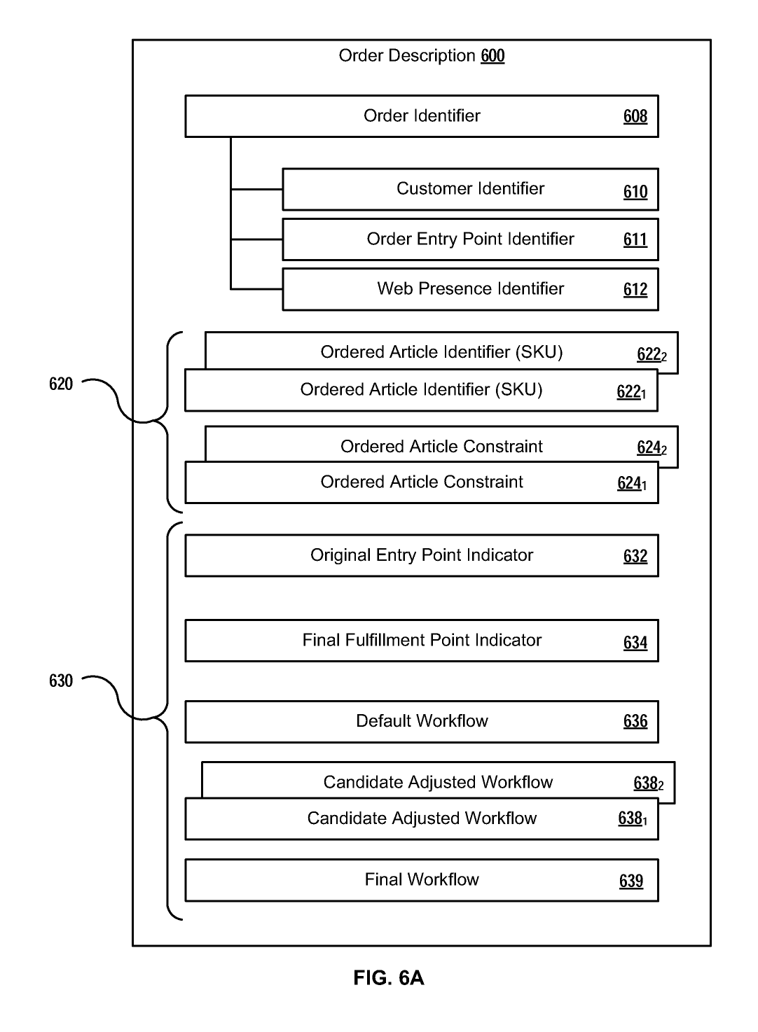

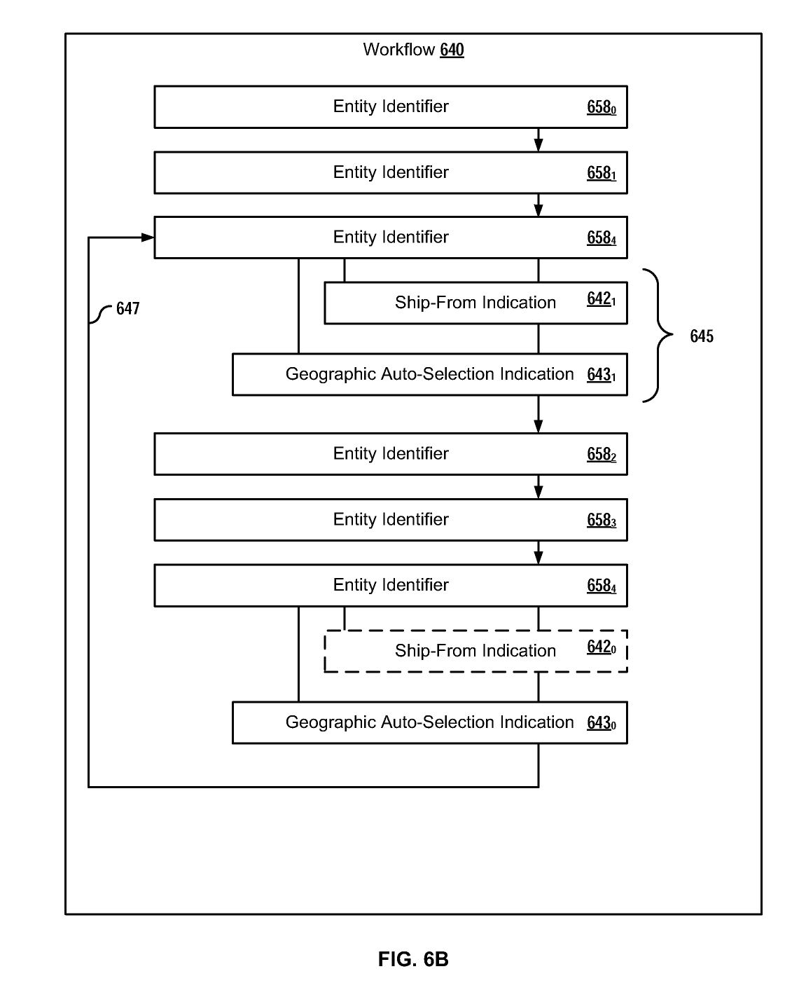

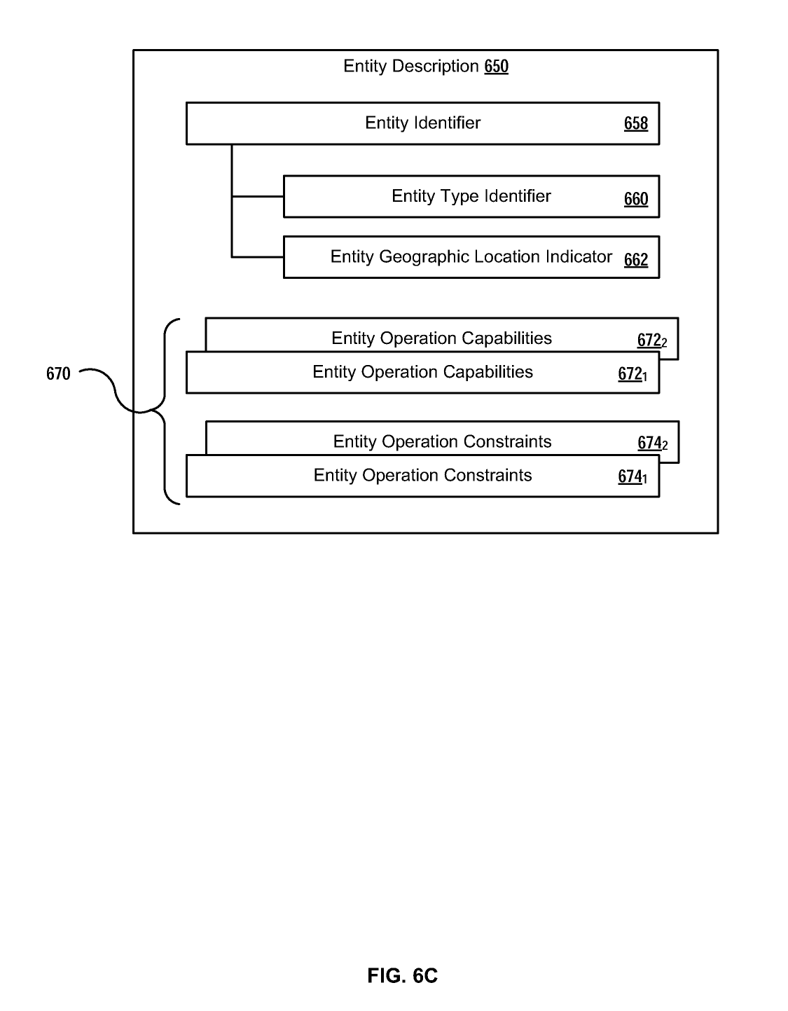

Now, referring to the the participants in the vendor network 380, the vendor may include any entity for providing performance of a service, or provision of production or manufacturing operations, or delivery of information, which entity may be described in a computer readable format such as a datastructure comprising an entity description (see FIG. 6C). In the example shown, routing of a customer order might commence when the dealer places an order with a stock article vendor 330. A stock article may be identified using known techniques, including a stock article identifier SKU, or an ordered article identifier SKU. In any case, a stock article vendor may be selected to procure the stock article. Once the stock article as per the customer order has been procured, then the flow might continue to a printing and binding vendor 340, followed by flowing to an assembly and packaging vendor 350, followed by flowing to a labeling and sorting vendor 360, followed by flowing to a shipping vendor 370, and then over a shipping segment 372 to the final fulfillment point 374. Any aspect of the flow of goods or information pertaining to fulfilling the order may be accomplished via communications or movement of materiel between vendors or, in some cases, the flow of goods or information pertaining to fulfilling the order may be accomplished via communications or movement of materiel between a vendor and a dealer 240 (or an admin 233).

Use of Web Presence Web Pages in a System for Computer-Aided Workflow with Operator-Biased Order Routing

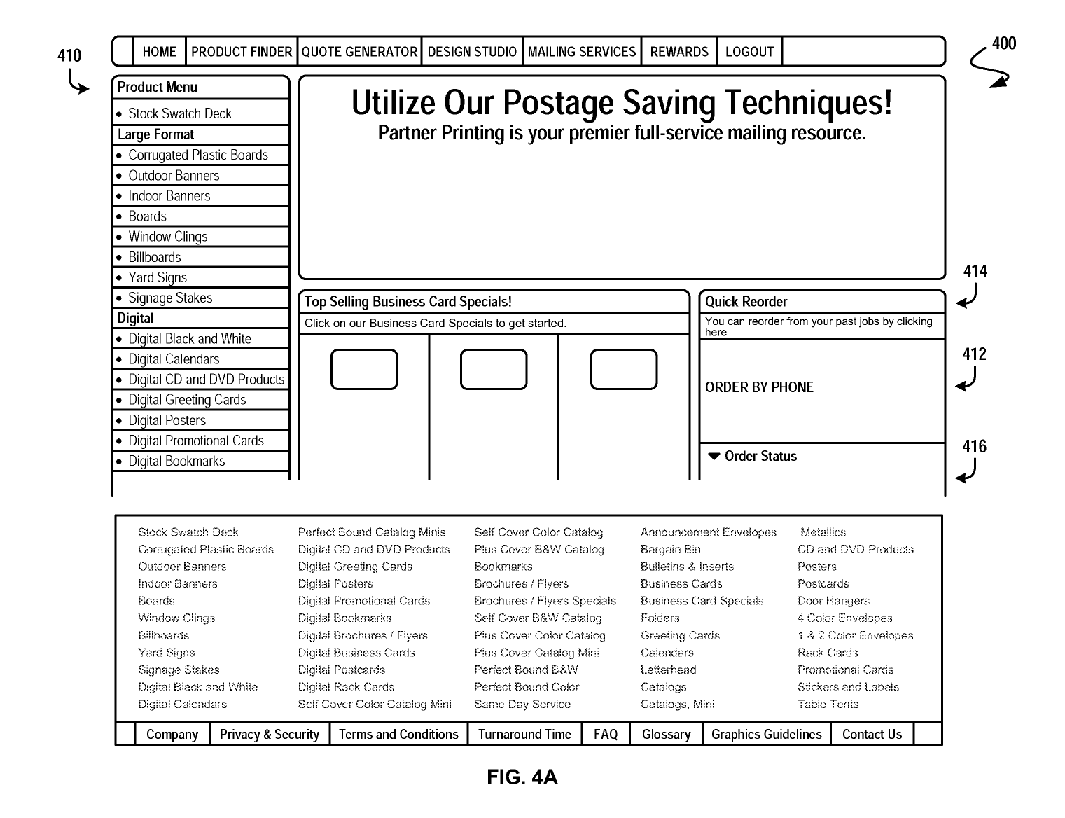

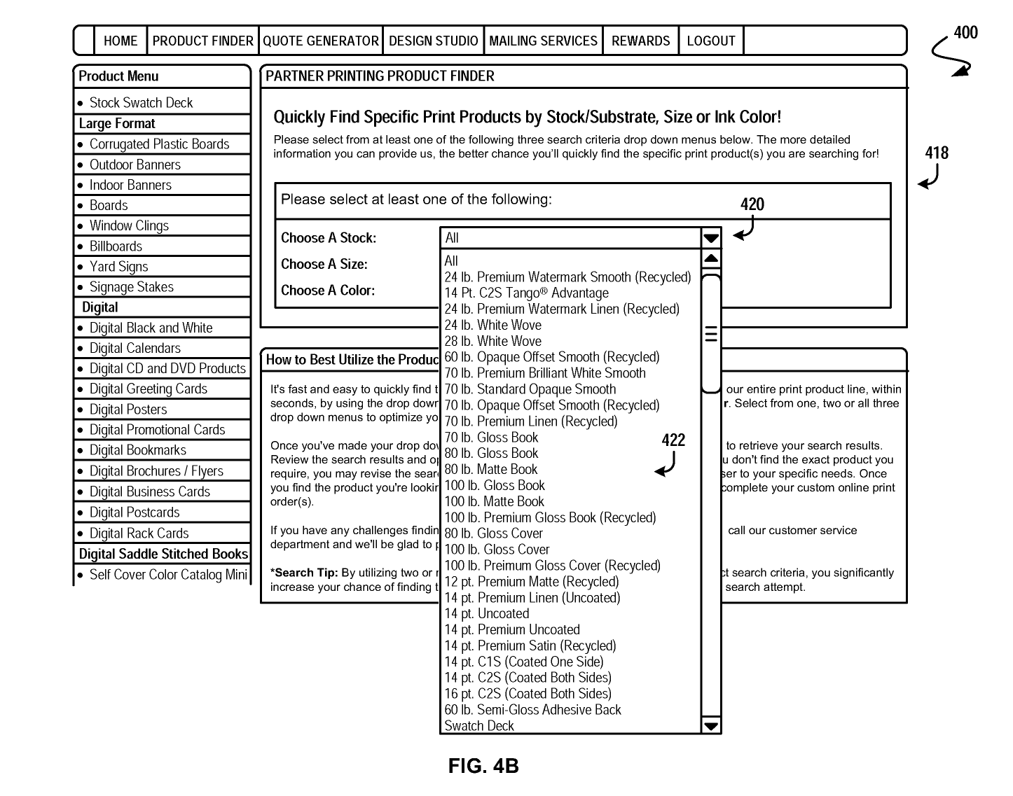

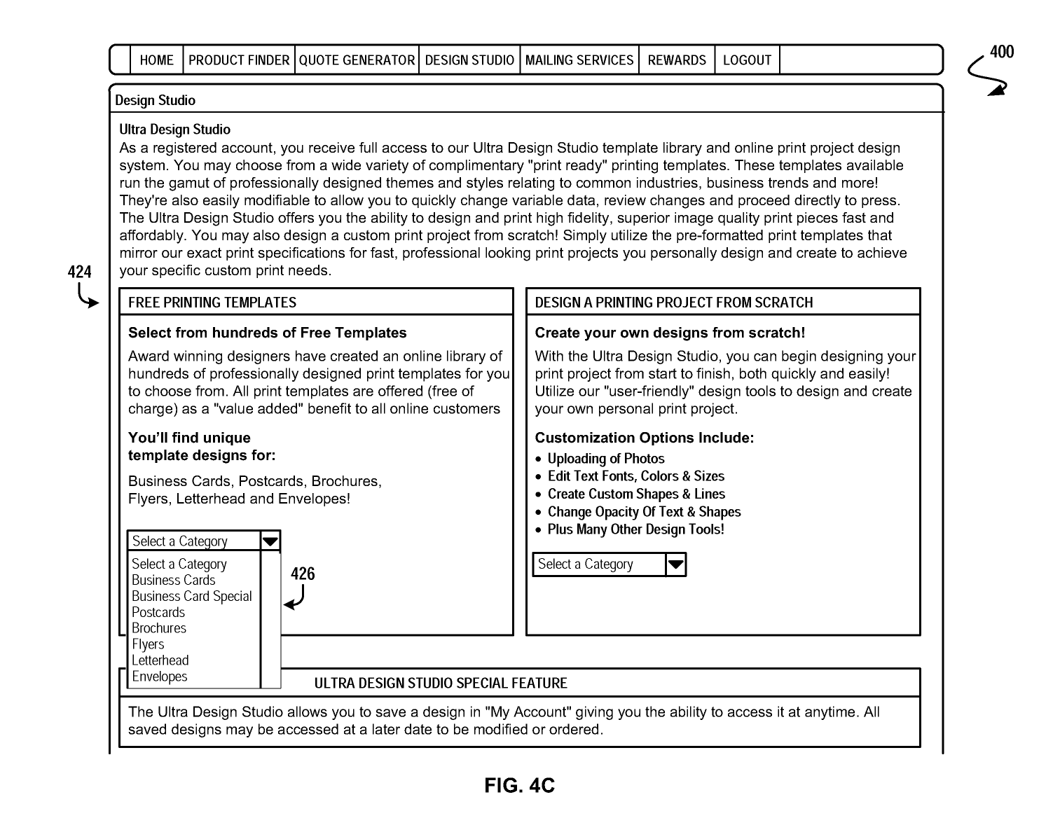

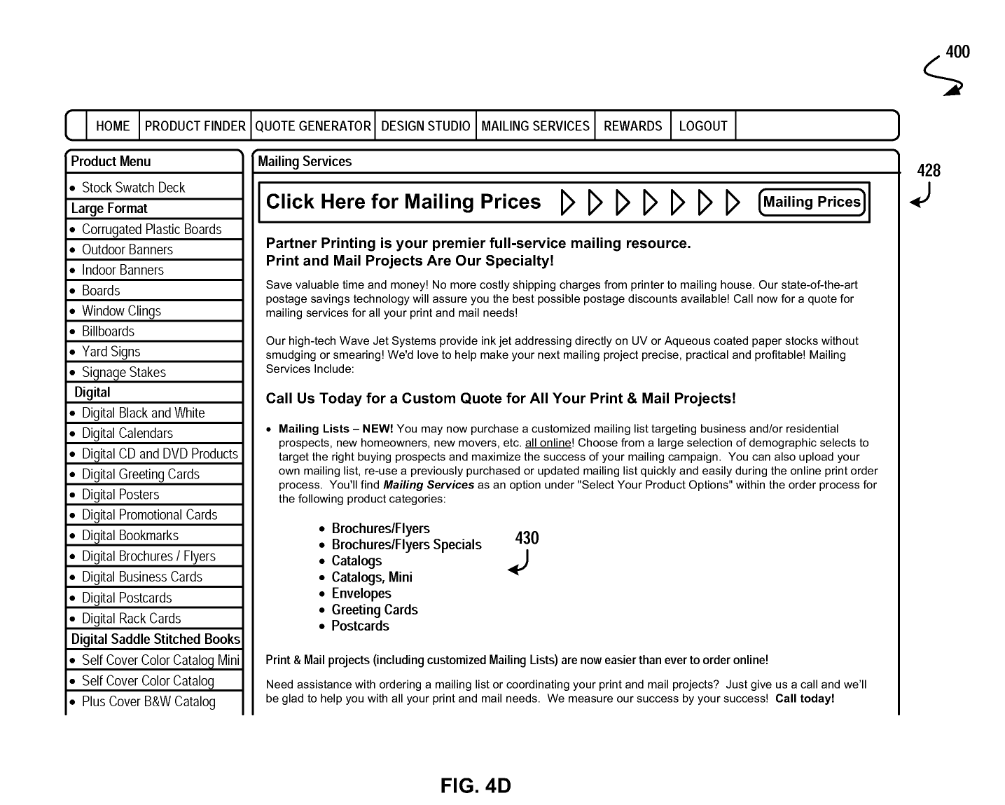

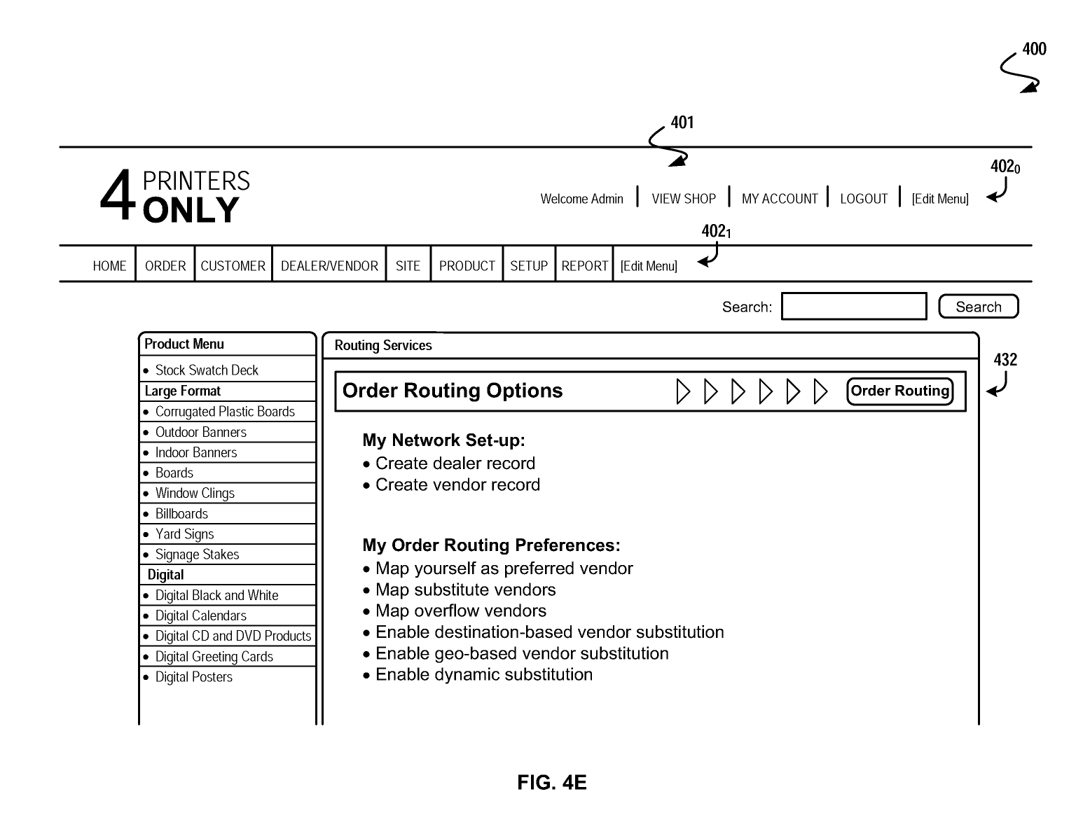

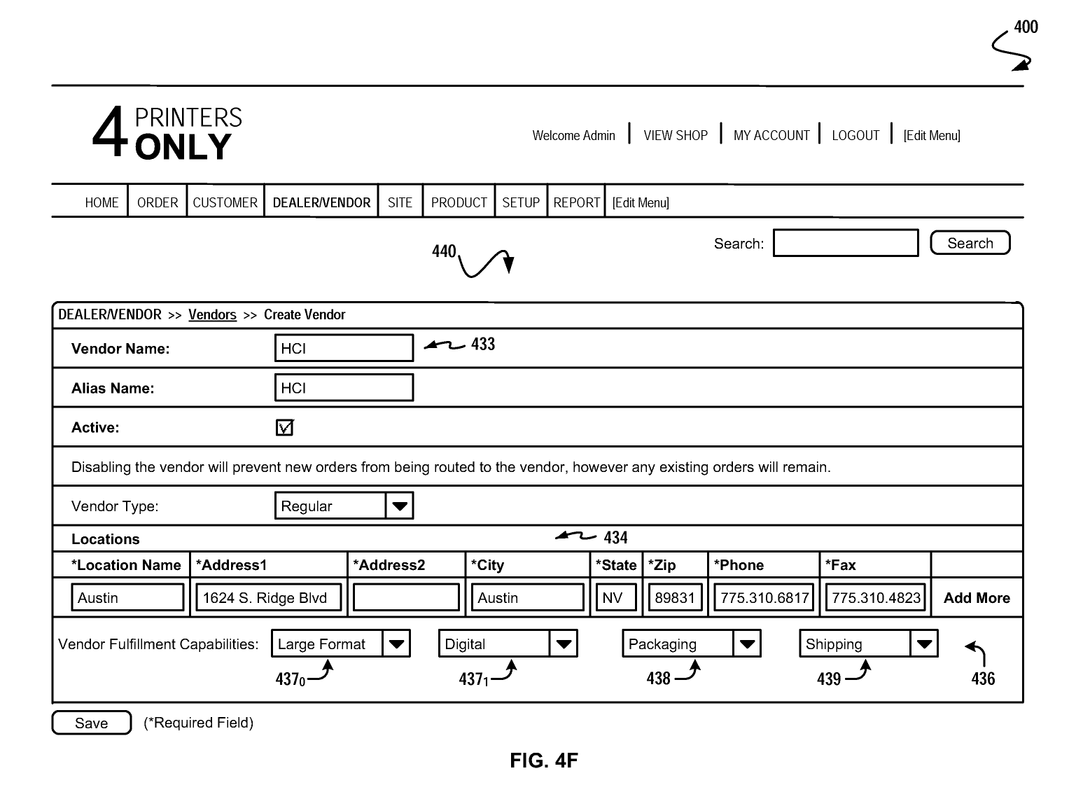

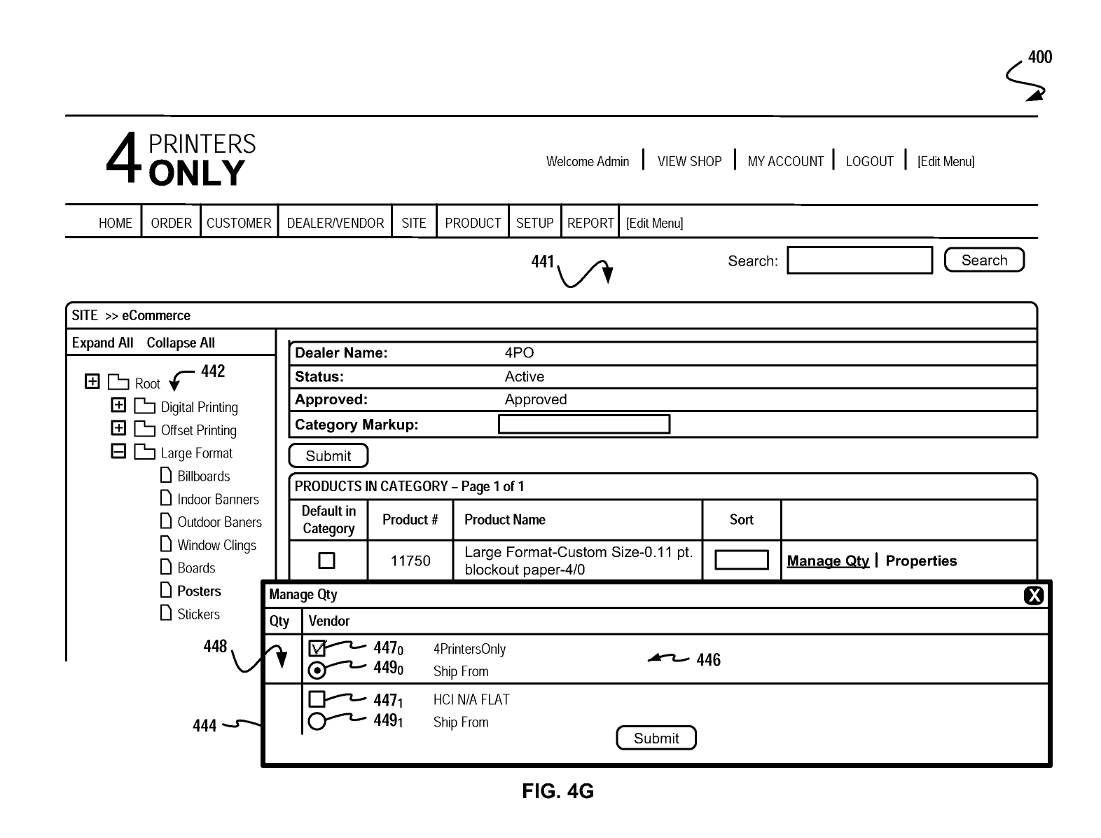

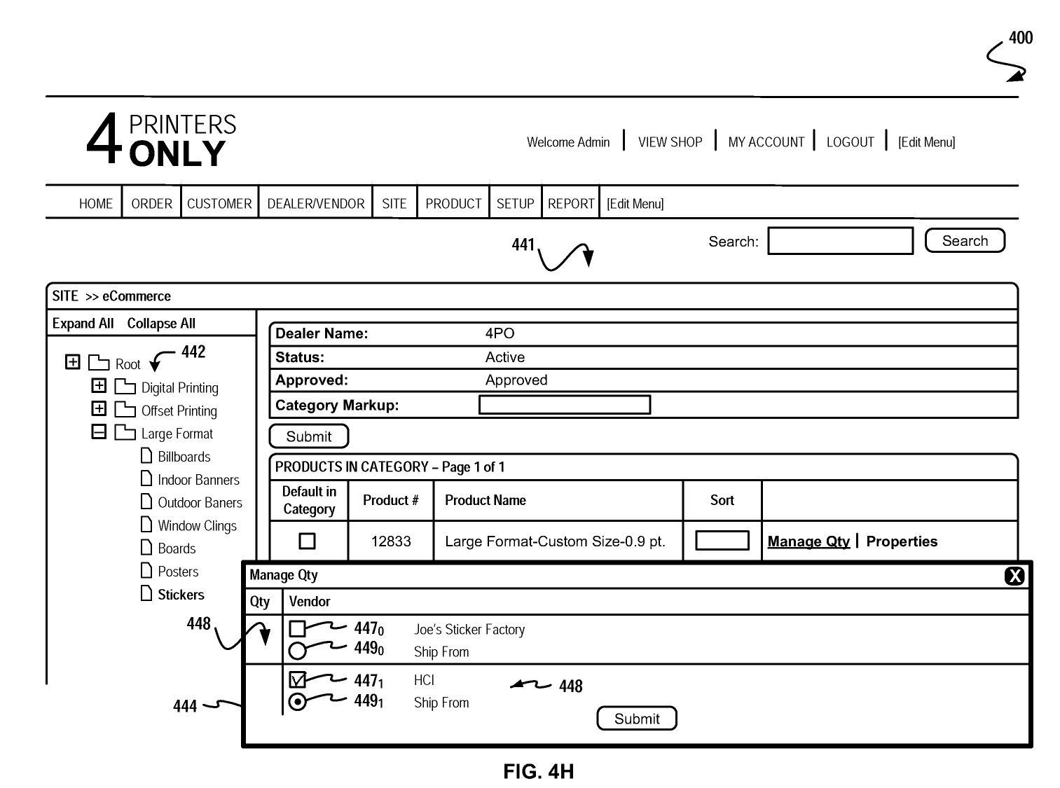

FIG. 4A depicts a web presence web page 400 from a website as produced by a content management system showing orderable product options. As shown, such a web presence web page 400 may include a product menu 410, which product menu includes a variety of stock items available for ordering. Such a web presence web page 400 may also include dynamic content, which dynamic content is output by components of a content management system (e.g. output by the web content management kernel 110). A customer may input an order description using one or more web pages such as web presence web page 400, or a customer may input an order description via telephone using the order by phone option 412. Once an order has been placed (see FIG. 4B), a customer may reorder using a reorder option 414. Regardless of the specific technique used by the customer for placing an order, a customer may check on the status of an order using the order status option 416.

FIG. 4B depicts a web presence web page 400 from a website as produced by a content management system showing customization options. As shown, such a web presence web page 400 may include one or more instances of a customization menu 418, which customization menu includes a variety of customization options 422 available for ordering. Such a web presence web page 400 may include dynamic content, which dynamic content may include a list of customization options 420. The list of customization options may be implemented as a display widget within a web page, which display widget may include a facility for displaying a dynamically populated list, the dynamically populated list being output by components of a content management system (e.g. output by the web content management kernel 110). Moreover, the elements of the list may be determined (at least in part) by the availability of the customization options, which availability may be determined by a content management system (e.g. output by the business process management kernel 115). In exemplary embodiments, availability may be determined using data from (or pertaining to) any one or more of the participants in the vendor network 380.

FIG. 4C depicts a web presence web page 400 from a website as produced by a content management system showing template options. As shown, such a web presence web page 400 may include one or more instances of a template menu 424 available for use when ordering a customized product. Such a web presence web page 400 may include dynamic content, which dynamic content may include a display widget for displaying a list of options, which list includes a variety of template options 426. The list of customization options may be implemented as a display widget within a web page, which display widget may include a facility for displaying a dynamically populated list of options, the dynamically populated list of options being output by components of a content management system (e.g. output by the web content management kernel 110). Moreover, the elements of the list of options may be determined (at least in part) by the availability of the template options, which availability may be determined by a content management system (e.g. output by the business process management kernel 115). In exemplary embodiments, availability may be determined using data from a dealer database 320 or from (or pertaining to) any one or more of the participants in the vendor network 380.

FIG. 4D depicts a web presence web page 400 from a website as produced by a content management system showing mailing options. As shown, such a web presence web page 400 may include one or more instances of a routing options widget available for use when ordering a customized product. Such a web presence web page 400 may include dynamic content, which dynamic content may include a display widget for displaying a list of mailing options, which list includes a variety of mailing options by product. The list of customization options may be implemented as a display widget within a web page, which display widget may include a facility for displaying a dynamically populated list of mailing options, the dynamically populated list of options being output by components of a content management system (e.g. output by the web content management kernel 110). Moreover, the elements of the list of options may be determined (at least in part) by the availability of the mailing options, which availability may be determined by a content management system (e.g. output by the business process management kernel 115). In exemplary embodiments, availability may be determined using data from a dealer database 320 or from (or pertaining to) any one or more of the participants in the vendor network 380. As an example, the mailing options for a physically bulky (e.g. catalogs) product may be different from the mailing options for flats (e.g. greeting cards), and such differences may be incorporated into a dynamically populated list of mailing options.

FIG. 4E depicts a web presence web page 400 from a website as produced by a content management system showing routing options. In exemplary embodiments, an e-commerce content management system outputs an entire website, with the web pages within the web site (e.g. any one or more customized web presence web pages 400) being customized so as to reflect the branding of the dealer or vendor. The branding colors or branding logos or other branding characteristics are output to one or more web presence web pages. For example, a web presence web page 400 may include a banner 401, which banner might be populated with the dealer's logo (e.g. see “4 PRINTERS ONLY”). Or, a web presence web page 400 may include a banner 401, which banner might be populated using a default set of menu items and/or a dealer-edited set of menu items. As shown, a default set of menu items 402 (e.g. menu items 402₀, menu items 402₁) are available to be customized by the dealer.

In the embodiments shown in FIG. 4E, the web presence web page 400 includes a routing option screen area 432. The routing option screen area presents options for the dealer to establish vendors in the dealer's network. Of course, a dealer's vendor network may be partially populated due to the dealer's subscription to an alliance. For example, a dealer, by licensing content management software for creating and managing a web presence, may also be enabled to refer to a group of certain vendors (e.g. alliance vendors) within the dealer's network. Moreover, such a group of certain vendors may be pre-populated into a web presence web site.

Using the the web presence web page 400 of FIG. 4E, the dealer may create vendor records, including establishing the dealer itself as a vendor. For example, a dealer might be in a good market position (e.g. by virtue of the dealer's existing or planned web presence on the Internet) in order to receive orders for “posters”. In some cases, the dealer may wish to have a third party vendor fulfill the order. In other cases, the dealer might be in a good market position by virtue of the dealer's web presence on the Internet, of also having the capability to produce “posters”. In such a case the dealer might wish to serve as the recipient of the orders for “posters” as well as serve as the manufacturer of the orders for “posters”. Given this scenario, the dealer may use a screen device to create a vendor record referring to the dealer itself as a vendor, and then use a screen device to establish order routing preferences. Such exemplary screen devices are presented in FIG. 4E and FIG. 4F.

More specifically, some embodiments support a routing option screen area 428 that includes one or more order routing preferences. Strictly as a example, such order routing preferences may be defined using the corresponding screen devices as shown routing option screen area 428. One possibility (as shown) is to permit the dealer to map itself as a vendor. Other order routing preferences are possible and envisioned, some of which possibilities are shown in FIG. 4E, a dealer may use a screen device for interactive vendor set-up (e.g. to create a vendor record).

FIG. 4F depicts a web presence web page 400 from a website as produced by a content management system showing interactive vendor set-up, according to one embodiment. In exemplary embodiments, creation of a vendor record is facilitated using a screen device for inputting a vendor description 440, and the vendor description 440 may comprise fields for identifying the vendors as well as for describing capabilities and limitations of the vendor. For example, an e-commerce content management system might include screen devices for inputting a vendor description 440. In exemplary embodiments, the vendor description 440 may comprise a vendor location indicator 434 (e.g. a street address, a zip code or postal code, a phone number etc) and an assortment of fulfillment capabilities. For example, a screen device might present fulfillment capability 436 as one or more pulldown menus, or as a series of radio buttons or checkboxes, or other screen devices. As shown, the e-commerce content management system produces a web presence web page that comprises screen devices to indicate a first printing capability 437₀, a second printing capability 437₁, a packaging capability 438, a shipping capability 439, etc. Of course the depiction of FIG. 4F is purely exemplary, and other screen devices are possible and envisioned, including screen devices presented on a touch screen, or screen devices responsive to multi-touch gestures. Using such screen devices, a dealer may establish itself as a vendor, and may further indicate an order routing preference such that certain orders will be routed to the dealer. Again referring to the example of “posters”, if the dealer were also a vendor capable of manufacturing posters, then the dealer might want to avail itself of dealer self routing options (see FIG. 4G) such that computer-generated workflows include the dealer/vendor in workflows that at least minimally satisfy the full set of ordered article constraints.

FIG. 4G depicts a web presence web page 400 from a website as produced by a content management system showing dealer self routing options, according to one embodiment. As shown, the web presence web page includes a screen device for inputting dealer preferences.

As earlier described, a dealer may possess capabilities to process certain types of orders. The earlier-mentioned case referred to the example of “posters”, however many other products are possible. For example, referring to embodiments according to FIG. 4G, a product listing 442 (e.g. a product hierarchy, a product tree) may be displayed, and a user may select a particular product or a category of products. The content management system presents an interface to allow a dealer (or, more particularly, an admin acting on behalf of a dealer), to further configure aspects of the dealer's performance, given an order for the selected product. In the example shown, the product category “posters” is selected, and the product configuration entry area 441 is presented with a listing of products in the product category. In this specific example, the specific product being configured is identified by “product #” given as “11750”, and by “product name” given as “Large Format-Custom Size-0.11 pt. blockout paper-4/0”. In operation, the dealer or admin 233 may manage quantity using the “manage qty” screen device (as shown). In this embodiment, activation of the “manage qty” screen device brings up an additional screen device for vendor descriptions 444, which includes a list of vendors capable of manufacturing an order for “product #' given as “11750”.

The inputting of dealer preferences may be accomplished by displaying a portion of dealer/vendor descriptions in a list. The list is made up of a series of vendor/dealer descriptions such that, as shown, the dealer's own vendor record is presented in the list. Given such a list, screen devices then serve to permit the dealer to select itself, by selecting itself from among the displayed vendor descriptions, the selected vendor being the dealer's own vendor record.

Thus, the dealer having identified itself as a vendor, the content management system may operate to determine workflows that include the dealer as a vendor. As is further discussed below, various workflows have the characteristic of at least minimally satisfying the manufacturing and processing steps to produce and finally fulfill the order (e.g. observing a set of ordered article constraints). In some embodiments, the content management system is delivered as a software title (e.g. on a CDROM or other computer readable media, or as software as a service), and the capability for generating workflows (e.g. the generated workflow including the selected dealer as a vendor) may be delivered as an optional module.

The aforementioned processing steps to produce and finally fulfill the order may be characterized using the content management system by defining capabilities and constraints. For example, and referring to FIG. 4F, a vendor may be marked as able to perform one or more printing capabilities 437, one or more packaging capabilities 438, one or more shipping capabilities 439, etc. Yet although a vendor (possibly a dealer/vendor) may support various ranges of printing capabilities 437 (e.g. the capability to produce “Large Format-Custom Size-0.11 pt. blockout paper-4/0”), it might only be able to produce certain quantities within a certain time period. Accordingly, a quantity field 448 is provided in order to enter a quantity constraint. Further, using a screen device for vendor descriptions 444, a dealer or admin may perform selecting operations using the displayed vendor descriptions, such as selecting one (or more) of the vendor descriptions 446, using a checkbox or other screen device to input the selected indication 447 and/or using a checkbox or radio button or other type of a ship-from screen device 449 to input a ship-from indication.

FIG. 4H depicts a web presence web page 400 from a website as produced by a content management system showing vendor substitution routing options, according to one embodiment. As shown, the web presence web page includes a screen device for inputting dealer preferences.

As earlier described, a dealer may possess capabilities to process certain types of orders. The earlier-mentioned case referred to the example of “posters”, however many other products are possible. It is possible that a dealer may not possess capabilities to process certain types of orders. For example, referring to embodiments according to FIG. 4G, a product listing 442 (e.g. a product hierarchy, a product tree) may be displayed. The content management system presents an interface to allow a dealer (or, more particularly, an admin acting on behalf of a dealer), to further configure aspects of the dealer's participation in the workflow (e.g. any step or steps from order entry to order fulfillment), given an order for the selected product. In the example shown, the product category “Stickers” is selected, and the product configuration entry area 441 is presented with a listing of products in the product category. In this specific example, the specific product being configured is identified by “product #” given as “12833”, and by “product name” given as “Large Format-Custom Size-0.9 pt.”. In operation, the dealer or admin 233 may manage quantity using the “manage qty” screen device (as shown). In this embodiment, activation of the “manage qty” screen device brings up an additional screen device for vendor descriptions 444, which includes a list of vendors capable of manufacturing an order for “product #' given as “12833”. As shown, the screen device for vendor descriptions 444 includes two vendors, namely, “Joe's Sticker Factory”, and “HCI”. Of course, other vendors might be listed in the screen device for vendor descriptions 444. The dealer or an admin acting on behalf of a dealer may select a vendor, and select a ship-from screen device 449. By selecting checkboxes or other screen devices in the screen device for vendor descriptions 444, a dealer or admin may perform selecting operations using the displayed vendor descriptions, such as selecting a ship-from screen device 449.

Use of an E-Commerce System for Computer-Aided Workflow with Operator-Biased Order Routing

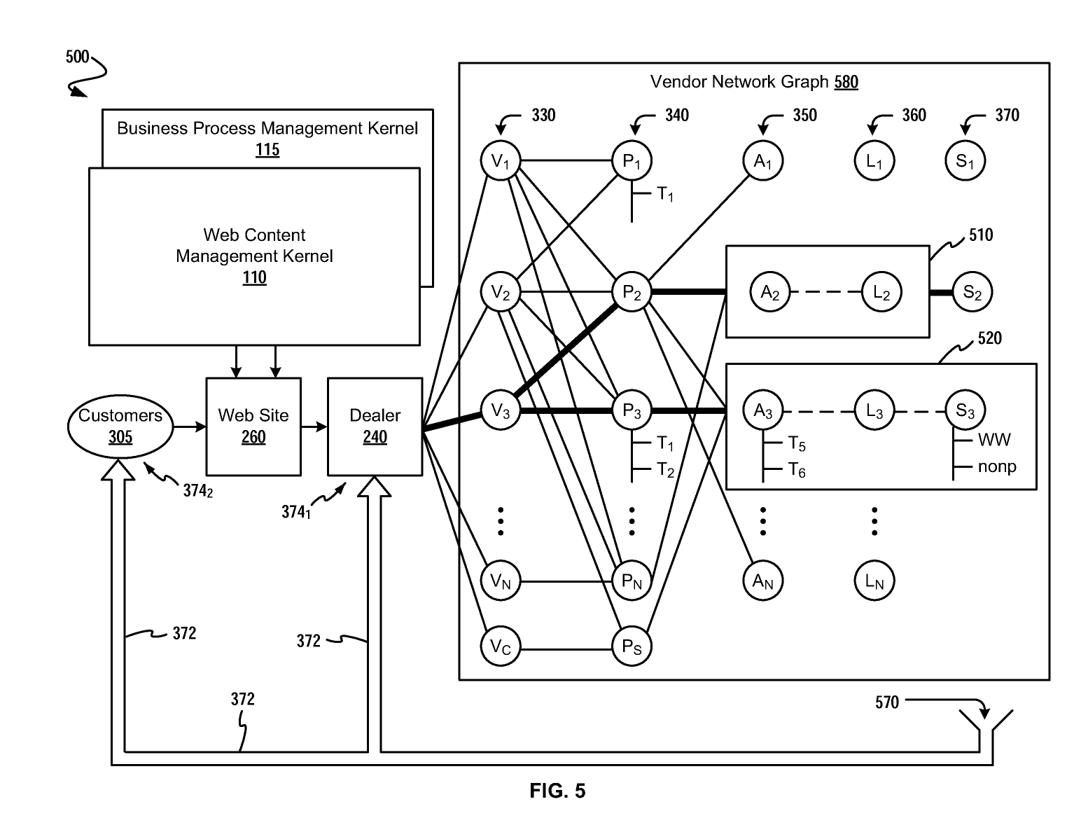

FIG. 5 depicts a schematic of an e-commerce system 500 showing workflows from receipt of an order through delivery to a final fulfillment point. Legacy techniques for managing the flow from customer requirements to customer satisfaction of delivered product or service rely substantially on human interaction to set up workflow parameters and deal with limitations or constraints of vendors. However, using the techniques disclosed herein, a vendor network graph 580 (e.g. in a machine readable format) may be used, and various computer-aided techniques may be employed to automatically define workflows in order routing. As shown, the system 500 includes customers 305, which customers place orders using a website 260, which orders in turn are provided to a dealer 240, and the dealer uses vendors (and/or itself) to fulfill the order. As earlier indicated, the dealer maintains a dealer database 320, which dealer database serves for organizing a network of vendors. In some embodiments, the dealer database 320 includes a machine-readable representation of a vendor network graph 580. Such a vendor network graph may be used to automatically define workflows in order routing. For example, consider an order for customized t-shirts for each player on a sports team, which order is to be shipped to a single location, yet each t-shirt is packaged and labeled individually (e.g. with a player's name on the packaging). Then, it may be envisioned that such an order requires raw materials (e.g. the un-customized t-shirt), printing (e.g. artwork for adding the team logo), assembly/packaging (e.g. packaging the customized t-shirt into a cellophane package), labeling (e.g. with the player's name on the outside of the cellophane package), and shipping (e.g. place all into a single carton and ship to the final fulfillment point as indicated in the order). Now, mapping the characteristics of the aforementioned order for customized t-shirts onto the vendor network graph, it may further be envisioned that there may be a vendor for the un-customized t-shirt (e.g. vendor=V1), a vendor for the logo artwork printing (e.g. vendor=V2), a vendor for the printing (e.g. vendor=P3), a vendor for assembly/packaging (e.g. vendor=A3), a vendor for labeling (e.g. vendor=L3), and a vendor for shipping (e.g. vendor=S3).

The exemplary assignment of vendors to the workflow for this t-shirt order routing imputes characteristics onto the assigned vendors such that all processes may indeed be performed by the assigned vendors, and further that the assigned vendors have any necessary commercial relationships in place, and still further that the assigned vendors have communication links sufficiently established so as to facilitate order flow (i.e. receive inputs, send outputs). This means that some vendor network graphs may have multiple workflows through the vendor network graph that are viable candidates for order flow (though it is also possible that some vendor network graphs may have zero workflows through the vendor network graph that are viable candidates for order flow).

As shown, the vendor network graph 580 includes a graphical depiction of an entity capable of performing the functions of more than one vendor (see the dual multifunction vendor 510 and the triple multifunction vendor 520). The construction of a set (e.g. via a bounding rectangle as shown) as a characteristic in a vendor network graph 580 may be used by a content management system (e.g. using a web content management kernel 110, a business process management kernel 115) to reduce the number of constraints involved in finding viable candidates for order flow.

As may be seen by inspection of network vendor graph of FIG. 5, the shown viable workflows for a workflow for the t-shirt order routing include one or more vendors, which vendors, in aggregate, are capable of performing all of the operations for processing the order from initial order steps to final order fulfillment. In particular, the shown viable workflows for the t-shirt order routing include one or more vendors capable of performing the shipping operations. A shipping vendor may be deemed as a shipping vendor merely if the vendor may drop a shipment to a shipping collection point 570, from which point the goods are transported over a shipping segment 372 to a final fulfillment point 374. As shown, a final fulfillment point may be a dealer-specified address (see final fulfillment point 374₁) or a final fulfillment point may be a customer-specified address (see final fulfillment point 374₂), or any address for that matter.

Note the occurrence of the markings on the network flow graph indicated as “T₁, “T₂”, “WW” and “nonp”. As shown, these marking refer to vendor capabilities and limitations of the vendor to which the marking(s) are attached. Capabilites are indicated using uppercase characters (e.g. “T₁”, or “WW”), limitations are indicated using lowercase characters (e.g. “nonp”).

In the example shown, the vendor S₃ has the capability to ship World-Wide (as shown, “WW”), with the limitation of no shipments to the North Pole (as shown, “nonp”).

A workflow is considered a viable workflow when the following conditions are satisfied:
All capabilities needed for processing the order may be performed by at least one vendor in the traversal of the workflow.
None of the limitations of any vendor on the workflow are violated by processing the order.

As may be readily understood by those skilled in the art, aspects of the order may be considered constraints, and the problem of finding one or more viable paths may be considered as an allocation/optimization problem, for which there are known techniques for finding solutions, both optimal solutions and non-optimal solutions. Thus, in the context of the embodiments herein, a viable workflow at least minimally satisfies the set of ordered article constraints. A viable workflow need not be an optimal workflow.

It is possible that multiple vendors possess the capability to perform a particular function for processing an order, hence it is possible that multiple viable workflows exist within a given vendor network graph. It is also possible than there exists no viable workflow within a given vendor network graph for processing an order. This may happen, for example, if there is no vendor that may process a particular step in the production/fulfillment of an order.

### Making Adjustments to a Default Workflow in a Vendor Network Graph

When there exists at least one viable workflow, then the at least one viable workflow may be presented in a web presence web page. It is also possible that there exists a plurality of viable workflows, and plurality of viable workflows may be presented in a web presence web page. When there exists exactly one viable workflow, then one viable workflow is termed a default workflow. When there exists a plurality of viable workflows, then one viable workflow selected from among the plurality of viable workflows is termed the default workflow.

Of course, in the presence of a plurality of viable workflows, the selection of a particular default workflow selected from among the plurality of viable workflows may be performed on the basis of one or more dimensions of a quantitative measure (e.g. optimizing for some quantifiable variable), or it may be performed on the basis of one or more dimensions of a qualitative measure (e.g. a user's preference, a dealer's preference, etc). Further, the selection of a particular default workflow selected from among the plurality of viable workflows may be performed on the basis of quantitative measures combined with qualitative measures. For example, selection of one viable workflow from among two viable workflows may be performed initially based on quantitative measures, and in the case of equal or nearly equal quantitative values, then a user bias may be introduced to break the tie (or near tie).

In some embodiments, the aforementioned user bias may be applied to a workflow to create a candidate adjusted workflow (the candidate adjusted workflow still at least minimally satisfying a set of ordered article constraints). For example, if the workflow (see in FIG. 5) from dealer 240 to shipping vendor S₂ is a viable workflow and also the workflow from dealer 240 to shipping vendor S₃ is also a viable workflow, then application of a user bias for preferring vendor S3 (stictly an example) may result in a candidate adjusted workflow. In another example, and specifically an example of a computer-aided workflow adjustment using user directed vendor substitution in order routing, if the workflow (see in FIG. 5) from dealer 240 to shipping vendor S₂ is a viable workflow and also the workflow from dealer 240 to shipping vendor S₃ is also a viable workflow, user's explicit request for vendor substitution may result in a candidate adjusted workflow.

Of course many other possibilities for producing a candidate adjusted workflow exist and are envisioned including:
adjusting a workflow using dealer self insertion in order routing
adjusting a workflow using user directed location-based vendor substitution in order routing
adjusting a workflow using dynamic vendor substitution techniques in order routing.

FIG. 6A depicts an exemplary data structure of an order description 600. As earlier described, an order description may comprise a default workflow and a module such as a business process management kernel 115 may be used for determining candidate adjusted workflow such that the commercial characteristics of the order description are satisfied, and the order is delivered to the intended final fulfillment point. As shown, an order description 600 comprises an order identifier 608, which (as shown) comprises a customer identifier 610 and a web presence identifier. Also shown are order data structures 620 for capturing the essence of the order in the form of instances of an ordered article identifier 622₁, an ordered article identifier 622₂ an ordered article constraint 624₁, and an ordered article constraint 624₂. The occurrence of multiple instances of the article identifier and multiple occurrences of the ordered article constraint is purely exemplary, and an order may comprise fewer (or more) such instances. The order description 600 also comprises a order workflow structures 630 for capturing the essence of workflows in the form of instances of a original entry point indicator 632, a next fulfillment point indicator 633, a final fulfillment point indicator 634, a data structure for a default workflow 636, a data structures for instances of a candidate adjusted workflow 638, and a data structure for a final workflow 639.

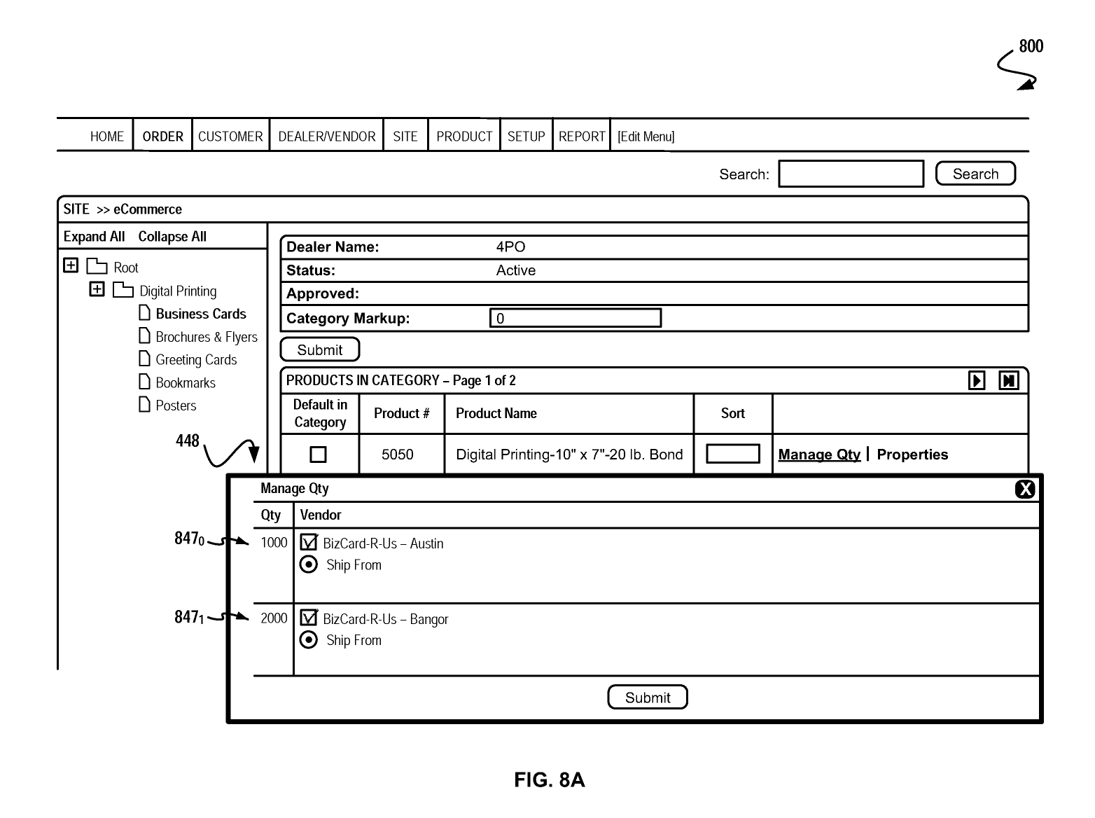

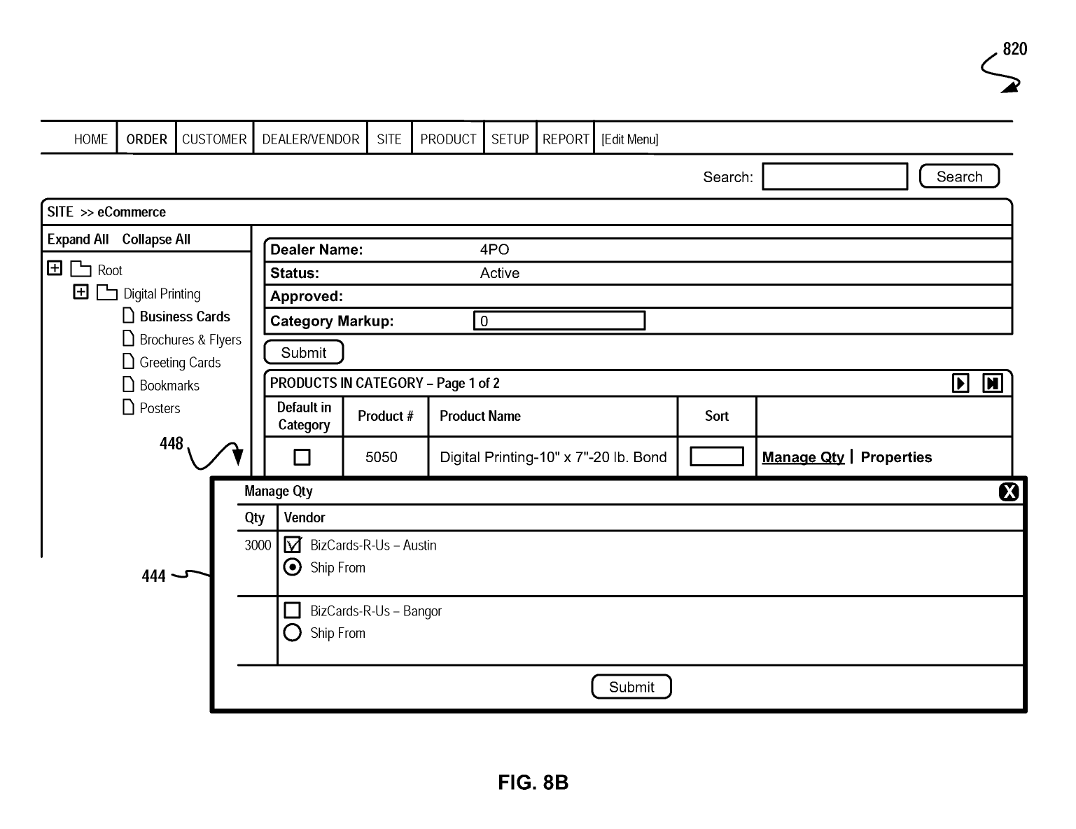

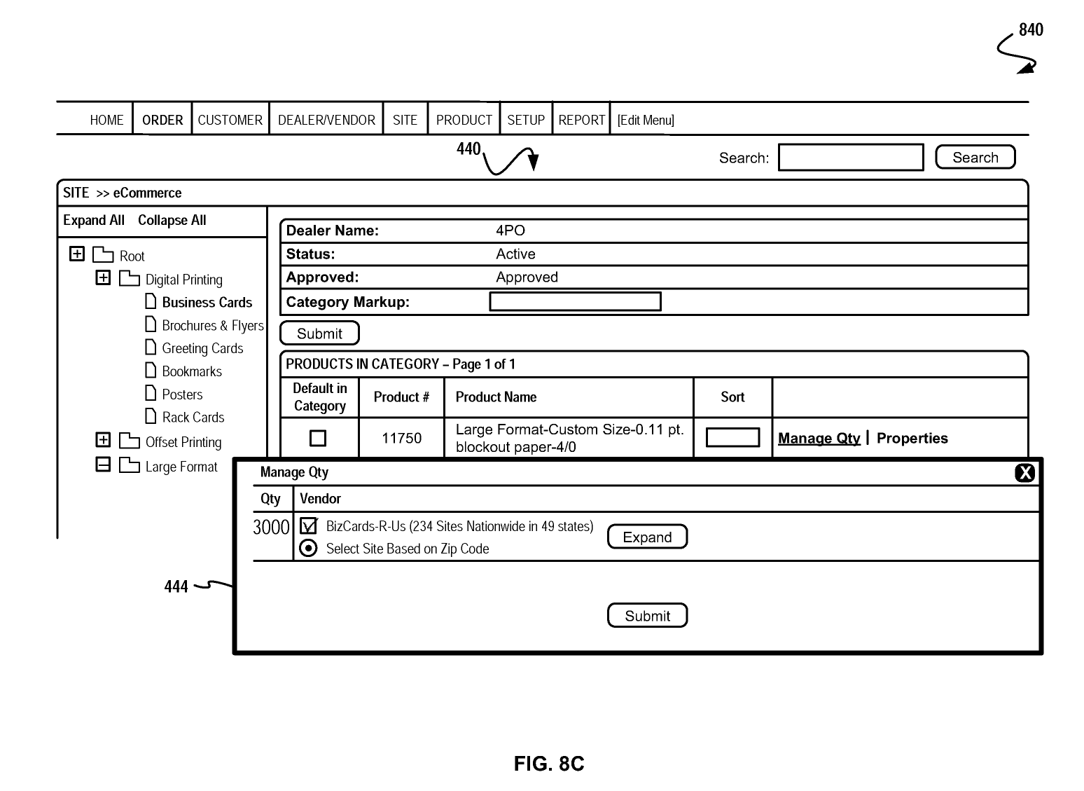

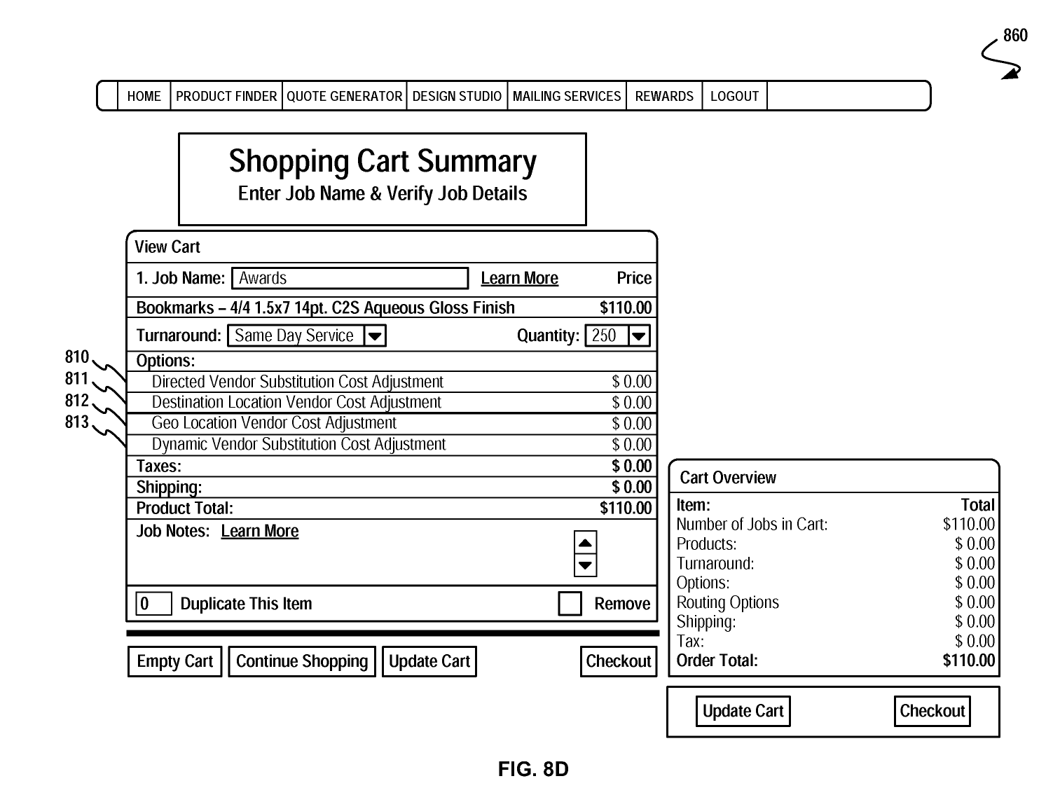

FIG. 6B depicts an exemplary data structure depicting a workflow 640. A workflow may comprise data structures to represent all or parts of a network graph, including a routes through entities such that the commercial characteristics of a corresponding order description 600 are satisfied, and the order is delivered to the intended final fulfillment point. A data structure of a workflow 640 is used by modules such as a business process management kernel 115 for enumerating workflows and filtering workflows based on capabilities and constraints. Accordingly, an instance of data structure depicting a workflow 640 includes an ordered list of entities formatted as an entity identifier, each entity to participate in the fulfillment of the order. In some instances of a workflow 640, an entity identifier is associated with an entity geographic location indicators 645. A ship-from indication 642 is one example of an entity geographic location indicator 645. As shown, a ship-from indication may be a present with a null indication (e.g. ship-from indication 642₀), or a ship-from indication may be a present with a non-null indication (e.g. ship-from indication 642₁). Moreover, the path through a workflow may encounter the same entity more than once (see loopback path 647). An entity geographic location indicator 645 may also include geographic auto-selection indication 643, further discussed below (see FIG. 8C).

FIG. 6C depicts an exemplary data structure of an entity description 650. As earlier described, an entity description may be comprised in a workflow and a module such as a business process management kernel 115 may be used for determining candidate adjusted workflow such that the commercial characteristics of the order description are satisfied, and the order is delivered to the intended final fulfillment point. As shown, an entity description 650 comprises an entity identifier 658, which (as shown) comprises an entity type identifier 660 and an entity geographic location 662. Also shown are entity operation data structures 670 for capturing the scope of the entity's operations in the form of instances of an entity operation capability identifier 672₁, and an entity operation constraint identifier 674₁.

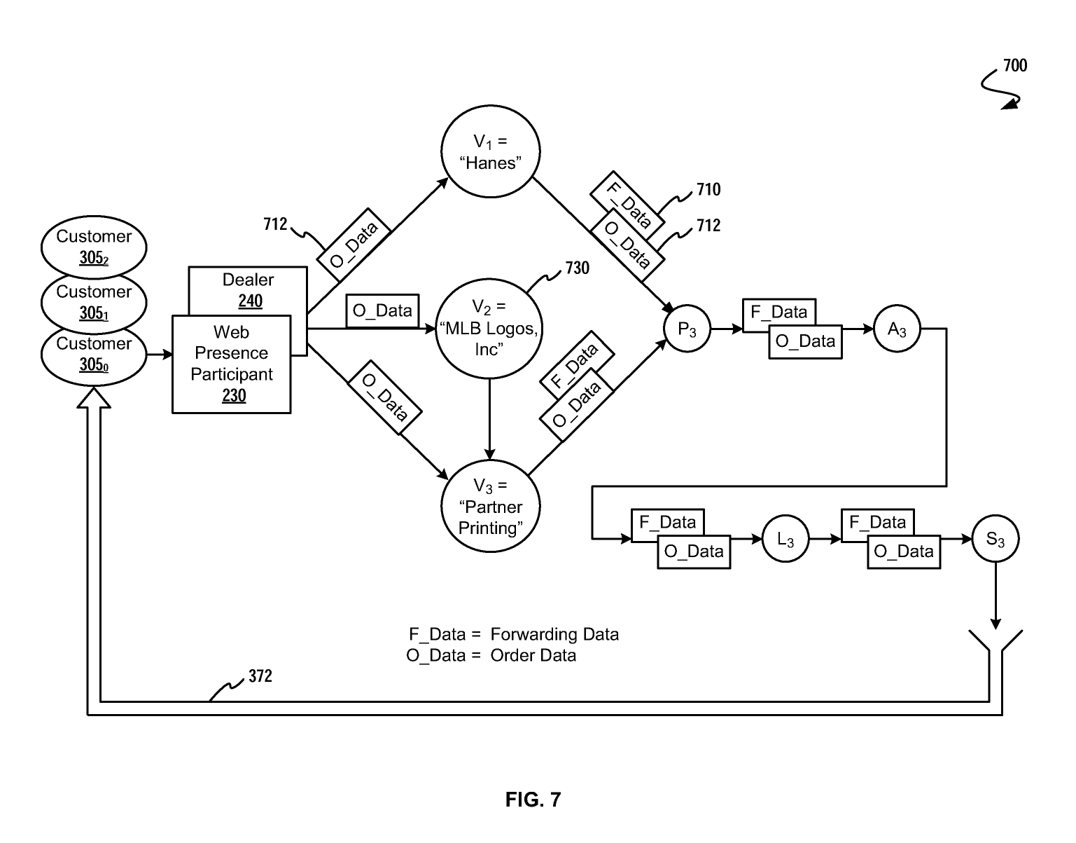

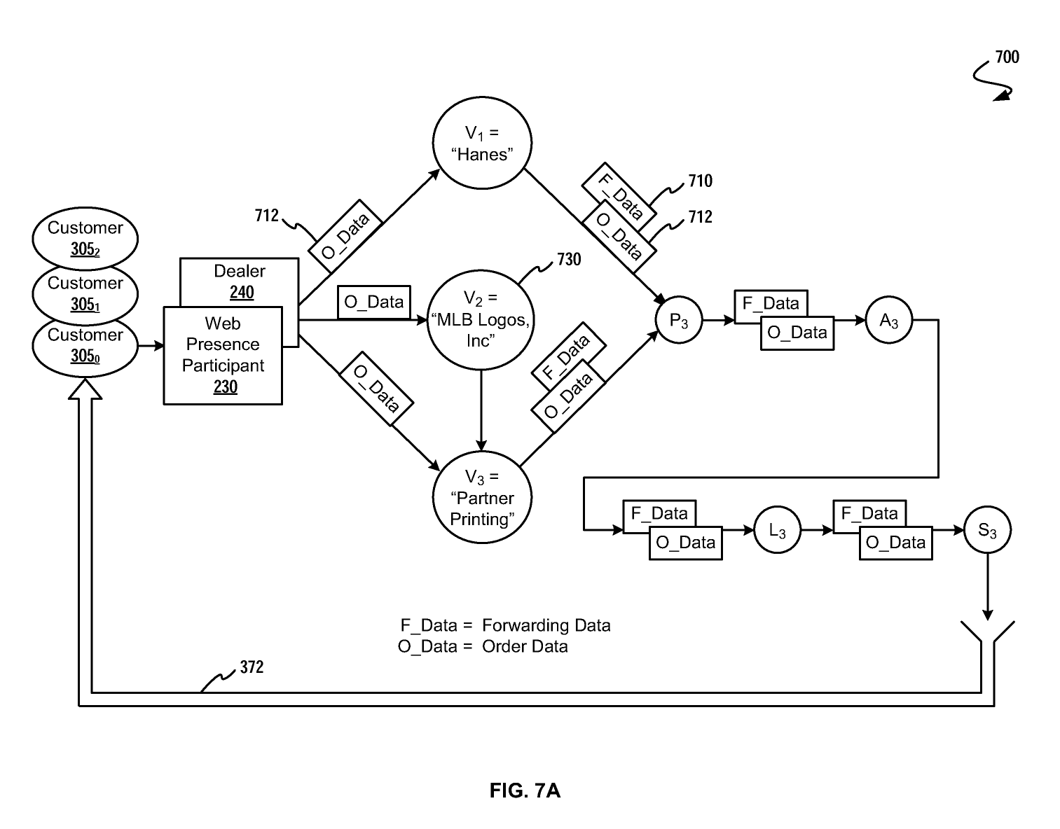

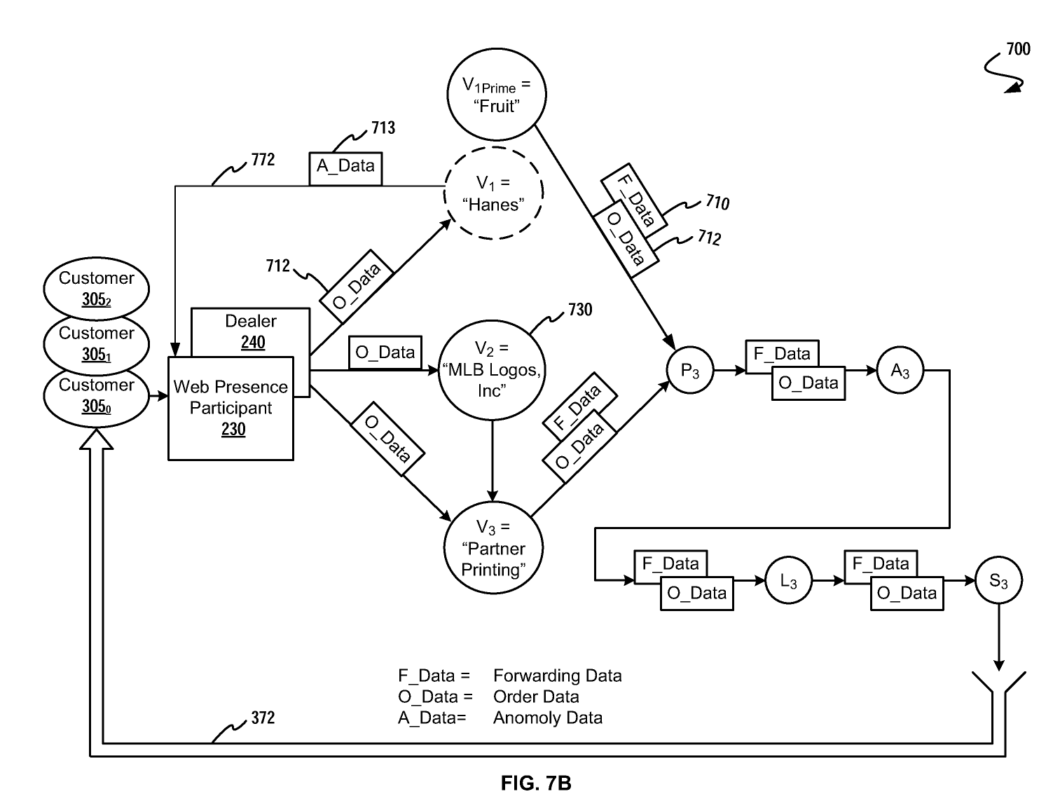

FIG. 7A depicts an exemplary workflow showing passing of forwarding data and order data between entities. In exemplary embodiments, an e-commerce content management system outputs web presence web pages to form a website for ordering and fulfillment under the multi-entity fulfillment scenario 700. As shown, the fulfillment involves multiple vendors (e.g. V₁, V₂, V₃), a packager (e.g. P₃), an assembler (e.g. A₃) , a labeler (e.g. L₃), and a shipper (e.g. S₃). Considering this flow as corresponding to an order for t-shirts for each player of a baseball team with a “Major League Baseball” logo emblazoned on a decal, which decal in turn is affixed to the t-shirt, and each fabricated t-shirt is individually wrapped (e.g. cellophane wrapping), labeled (e.g. with the player's name) and shipped to the player's home address.

In this scenario, the fulfillment involves not only movement of goods (e.g. inter-vedor shipment of the t-shirts as they move through the manufacturing processes) but also movement of data (e.g. inter-vedor movement of order data and forwarding). Order data is any data pertaining to the order at any point in time. For example order data may be captured in an order description 600, and such an order description changes at least in the aspect that the next fulfillment point indicator 633 changes as the materiel moved through the manufacturing processes. In the example shown, order data (e.g. O_Data 712) originates from the dealer 240, and order data is delivered to vendor V₁ (e.g. an order to “Hanes” for the t-shirts), and order data is delivered to vendor V2 (e.g. an order to the licensing authority for “MLB Logos, Inc.”), and order data is delivered to V3 (e.g. an order for printing the logo on a decal to “Partner Printing”). In combination, the abovementioned order data is sufficient to manufacture the ordered articles (e.g. t-shirts for each player of a baseball team with a “Major League Baseball” logo emblazoned on a decal, and affixed to the t-shirt), although other fulfillment steps remain (e.g. assembly, packaging, labeling, and shipping). In some cases, as the materiel moves through the fulfillment process, data in addition to the O_Data 712 is communicated intra-vendor. For example, when vendor V1 fulfills the (plain) t-shirt order, in addition to the order data, vendor V1 also sends forwarding data F_Data to a next fulfillment point (e.g. P₃). Forwarding data may be sent by a vedor to a next vendor or fulfillment point at any time, and in particular when the vendor has completed its processing step(s).

Following the assembly of the t-shirts, forwarding data and order data is communicated through the network of entities, and arrives at vendor S₃. Vendor S3 receives instructions (e.g. in the order data) to ship a particular article to a particular address, and does so via shipping segment 372, the particular article to the particular customer (e.g. customer 305₀, customer 305₁, etc).

FIG. 7B depicts an exemplary workflow showing passing of forwarding data and order data from an entity to a web presence participant, according to one embodiment. Following the example of FIG. 7A, an e-commerce content management system outputs web presence web pages to form a website for ordering and fulfillment under the multi-entity fulfillment scenario 700. As shown, the fulfillment involves multiple vendors (e.g. V₁, V₂, V₃), a packager (e.g. P₃), an assembler (e.g. A₃), a labeler (e.g. L₃), and a shipper (e.g. S₃), and within this context, techniques for dynamic vendor substitution in order routing may be practiced. More particularly, a vendor may be substituted in the workflow even after materiel has begun to be moved through the manufacturing processes. For example, and as shown, it might be the case that a vendor suffers an unexpected event (e.g. resulting in a time delay) or otherwise suffers from some anomaly (e.g. unexpectedly out of stock). In such cases, the vendor suffering the anomaly may inform the web presence participant (e.g. a dealer) using anomaly data (see A_Data 713) over network path 772. Then, the original vendor (e.g. vendor V₁) may be dynamically substituted (e.g. by the e-commerce content management system), and the substitute vendor (e.g. vendor V_{1Prime}.) takes the place of the original vendor, to perform steps to fulfill the order. Upon completion of acts by the substitute vendor to perform steps to fulfill the order, the substitute vendor sends forwarding data and order data to the next entity (or entities). In the example of FIG. 7B, “Hanes” suffered an anomaly, and vendor “Fruit” was substituted into the workflow.

An e-commerce content management system may be configured to generate a computer-aided workflow using dynamic vendor substitution in order routing. Various individual modules may be configured to cooperate for order fulfillment. For example, such an e-commerce content management system includes a module for inputting a vendor description (e.g. t-shirts for each player of a baseball team with a “Major League Baseball” logo emblazoned on a decal), which order may be forwarded to a module for receiving an order description. As discussed above an order description may comprise ordered article constraints (e.g. a fulfillment date) and at least one final fulfillment point indicator (e.g. ship to team headquarters). Given an order as just described, then a module may be configured for determining at least one candidate workflow, the candidate workflow at least minimally satisfying the set of ordered article constraints. Such a candidate workflow might be presented as a default workflow, or it might be a candidate workflow that is user-directed, possibly using any one or more of the aforementioned techniques.

In the event of an anomaly affecting an entity (e.g. a first vendor) participating in the candidate workflow, the entity may communicate the existence and nature of the anomaly in the form of a message (e.g. A_Data) to a module for recognizing and processing such an anomaly. The commerce content management system may take corrective measures based on the existence and nature of the anomaly. In operation, and particularly for taking corrective measures after an anomolous event, a module for determining a candidate adjusted workflow to mitigate the anomaly is tasked to generate such a candidate adjusted workflow (e.g. by dynamically substituting in a second vendor), yet still observing the final fulfillment point indicator, and still satisfying the set of ordered article constraints. In some cases, the second vendor (the substitute vendor) might possess a broader range of capabilities than the first vendor (e.g. capabilities of a third vendor), in which case the second vendor might be substituted for both the first vendor as well as a third vendor.

FIG. 8A depicts a web presence web page from a website as produced by a content management system showing order splitting options, according to one embodiment. Embodiments corresponding to the multi-entity fulfillment scenario 700 involve multiple vendors in the overall fulfillment process. There are still yet additional techniques to involve multiple vendors in the overall fulfillment process, namely, order splitting. In some cases, an order is too large to be timely fulfilled by a single vendor, and a dealer or admin might split the order among multiple vendors, splitting by quantity.

The order splitting scenario 800 depicts such a case, where the order (e.g. an order for business cards) is split between two vendors by quantity. As shown a first vendor, “BizCards-R-Us—Austin” is given an order for 1000 business cards (e.g. using quantity split 874₀), and a second vendor “BizCards-R-Us—Bangor” is given an order for 2000 (e.g. using quantity split 874₁) business cards. Both vendors are given instructions pertaining to shipment via the indication given using the ship-from screen device 449.

FIG. 8B depicts a web presence web page from a website as produced by a content management system showing location-based routing options using an order destination location, according to one embodiment. As discussed in the embodiment of the order splitting scenario 800 (see FIG. 8A) it might occur that a vendor (e.g. “BizCards-R-Us”) might have multiple sites, some or any or all of which have particular order fulfillment capabilities that would permit the site to participate in order fulfillment. In such as case, and given that a content management system may enumerate viable candidates for order flow, it is possible that some vendor network graphs may have a viable workflow for each site (e.g. each site for “BizCards-R-Us”). As shown in FIG. 8B, the screen device for vendor descriptions 444 comprises two vendors, each vendor capable to participate in order fulfillment. As in previous examples, the dealer may select using a checkbox or other screen device to input the selected indication and/or using a checkbox or radio button or other type of a ship-from screen device. However, using a geographic auto-selection indication 643 (see FIG. 6B), the content management system may automatically select a particular vendor based on the geographic location of the particular vendor relative to the geographic location of the final fulfillment point. As an example, if the final fulfillment point is listed as “Austin”, then the content management system may automatically select the vendor “BizCards-R-Us—Austin”, and may automatically select the ship-from screen device for that vendor (as shown). Of course, the dealer may override the automatic selection using a checkbox or other screen devices.

FIG. 8C depicts a web presence web page from a website as produced by a content management system showing location-based routing options using a vendor site location. As discussed in the embodiment of the order splitting scenario 800 (see FIG. 8A) it might occur that a vendor (e.g. “BizCards-R-Us”) might have multiple sites, some or any or all of which have particular order fulfillment capabilities that would permit the site to participate in order fulfillment. In such as case, and given that a content management system may enumerate viable candidates for order flow, it is possible that some vendor network graphs may have a viable workflow for each site (e.g. each site for “BizCards-R-Us”).

In some cases, a vendor with multiple sites may be coalesced under a single vendor name, and the enumerated viable accommodates for order flow include the site that is located in a geographic location that facilitates order flow to final fulfillment. As shown, the vendor “BizCards-R-Us” may be coalesced under a single vendor name “BizCards-R-Us (234 Sites Nationwide in 49 states”. Enumeration of viable candidates for order flow may be pruned to include only the site or sites that are located in a geographic location that facilitates order flow to final fulfillment. For example, if the final fulfillment point is listed as “Austin”, then the content management system may automatically select the vendor “BizCards-R-Us—Austin” (not shown in FIG. 8C) from the multiple sites coalesced under “BizCards-R-Us (234 Sites Nationwide in 49 states)”. The embodiment of FIG. 8C shows the vendor as “BizCards-R-Us (234 Sites Nationwide in 49 states”, although the actual site automatically selected, namely “BizCards-R-Us—Austin” is not shown. Of course, the dealer may override the automatic selection using a checkbox or other screen devices, and in some cases a screen device such as an “Expand” button is provided to permit display of the individual sites from among the multiple sites coalesced under “BizCards-R-Us (234 Sites Nationwide in 49 states)”.

Now, combining the teaching herein, an e-commerce content management system may be built and configured to generate a workflow using user location-based vendor substitution in order routing. Such an e-commerce content management system might comprise a module for receiving an order description (possibly using a web presence web page), the order description comprising multiple workflows (see FIG. 6B) for processing the order through entities having entity geographic location indicators (e.g. for ship-from indication, or for auto-selected geo routing). The aforementioned or other web page may capture the user confirmation of a workflow that includes a particular selected entity (e.g. the user selected a particular selected entity due to the geographic location of the participants), and send the user confirmation to a module for receiving such a user directed vendor substitution confirmation. In exemplary embodiments, an e-commerce content management system might include a module for determining and displaying the user confirmed workflow, where the candidate adjusted workflow comprising the selected entity, and the candidate adjusted workflow at least minimally satisfying a set of ordered article constraints. In some cases, a user will select particular selected entity (e.g. using a ship-from indication) due to the geographic proximity of the particular selected entity to the final ship-to location. Or, in some cases, a user will select an auto-selected entity (e.g. using a geographic auto-selection indication) due to the geographic proximity of the particular auto-selected entity to the final ship-to location (as in the case of the above “BizCards-R-Us—Austin” example).

FIG. 8D depicts a web presence web page 400 from a website as produced by a content management system showing pricing adjustments in a shopping cart summary 860. As shown, a web presence web page 400 may include one or more instances of a shopping cart summary, which shopping cart summary is available for use when ordering a customized product. Such a shopping cart summary 860 may include pricing summaries, including adjustments in form of a directed vendor substitution cost adjustment 810, a of a geo location vendor cost adjustment 811, a destination vendor cost adjustment 812, of a dynamic vendor cost adjustment 813.

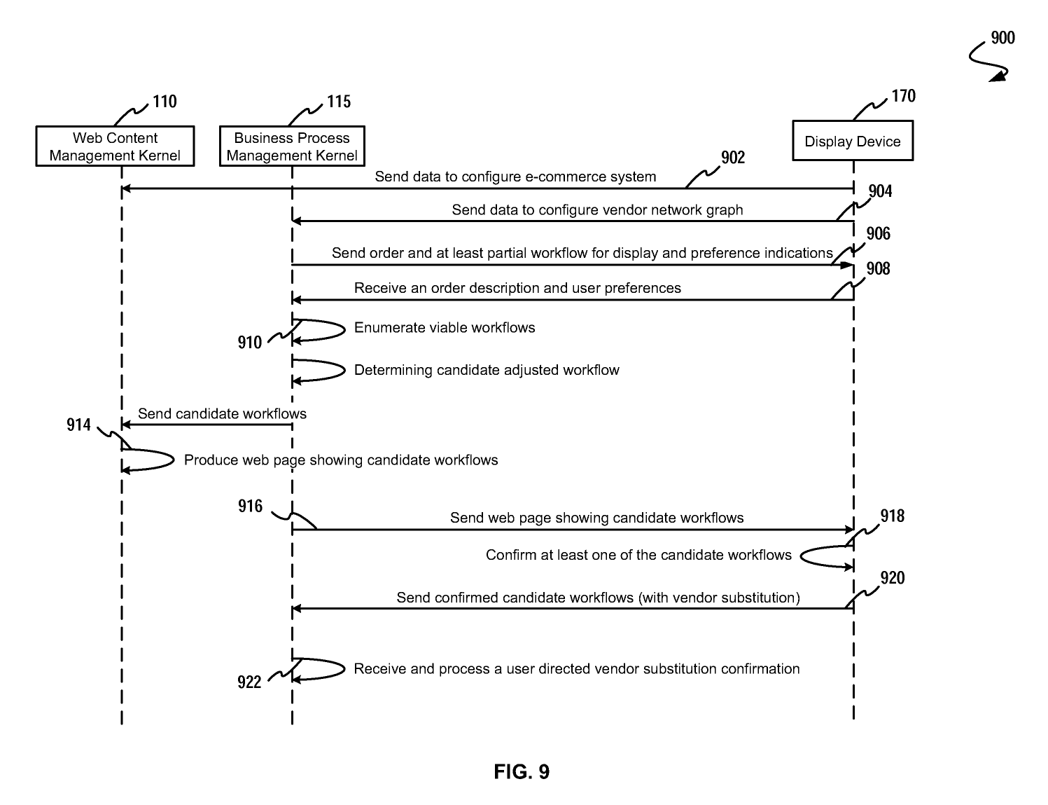

FIG. 9 depicts a protocol for implementing a computer-aided workflow with operator-biased order routing. The protocol 900 implements messages and operations used in an e-commerce content management system for generating a computer-aided workflow using user directed vendor substitution. In this embodiment, the content management system includes a module for inputting vendor descriptions, and the input data is sent to a web content management kernel 110 (see message 902). In addition the system includes a module for displaying portions of vendor descriptions, and/or dealer descriptions, and a vendor description or dealer description may include fulfillment capabilities 436, which fulfillment capabilities are used in configuring a network graph (see message 904), which network graphs are calculated in a kernel, and formatted, possibly together with information pertaining to a particular order for display on display device 170 as an order description. Additionally, such a system includes a module for receiving such an order description, the order description comprising at least one default workflow and at least one final fulfillment point indicator (e.g. zip code of the customer's ship-to address). The aforementioned kernel serves as a module for determining viable default workflows, the viable default workflows at least minimally satisfying a set of ordered article constraints. Using a display device 170, a user (e.g. a dealer or a customer) may interact with a computer-generated web page for displaying viable default workflows, and establishing preferences. Results of the interaction are sent to a kernel (see message 908) and the kernel, in turn enumerates (or eliminates) workflows based on viability and preferences in order to a candidate adjusted workflow. In some embodiments multiple kernels are used, for example, a web content management kernel 110 and a business process management kernel 115. The kernels may communicate cooperatively to accomplish the messaging and operations involved in protocol 900. For example, and as shown, a business process management kernel 115 sends candidate adjusted workflows to web content management kernel 110, and the web content management kernel in turn lays out a web page showing the candidate adjusted workflows (see operation 914), which web pages are then displayed on display device 170 for user confirmation of a selected candidate workflow, the selected candidate workflow possibly including a vendor substitution. The protocol 900 further supports communication to/from a module for receiving user directed vendor substitution confirmation. As shown, the acts of user directed vendor substitution confirmations uses the computer-generated web page (see message 916 and operation 918), and sends the confirmation to a kernel (see message 920 for processing by the kernel (see operation 922).

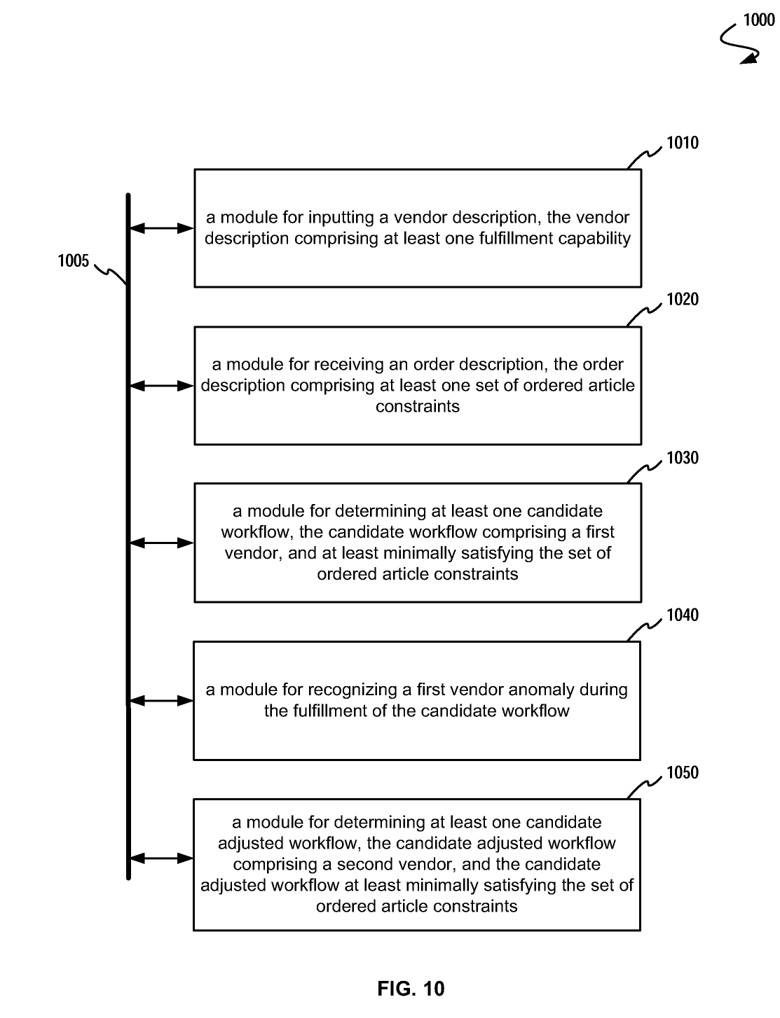

FIG. 10 depicts a block diagram of a system to perform certain functions of an e-commerce content management system. As an option, the present system 1000 may be implemented in the context of the architecture and functionality of the embodiments described herein. Of course, however, the system 1000 or any operation therein may be carried out in any desired environment. As shown, system 1000 comprises a plurality of modules, a module comprising at least one processor and a memory, each module connected to a communication link 1005, and any module may communicate with other modules over communication link 1005. The modules of the system may, individually or in combination, perform method steps within system 1000. Any method steps performed within system 1000 may be performed in any order unless as may be specified in the claims. As shown, FIG. 10 implements an e-commerce content management system as a system 1000, partitioned into modules, a module comprising at least one processor and a memory, and including a module for inputting a vendor description, the vendor description comprising at least one fulfillment capability (see module 1010); a module for receiving an order description, the order description comprising at least one set of ordered article constraints (see module 1020); a module for determining at least one candidate workflow, the candidate workflow comprising a first vendor, and at least minimally satisfying the set of ordered article constraints (see module 1030); a module for recognizing a first vendor anomaly during the fulfillment of the candidate workflow (see module 1040); and a module for determining at least one candidate adjusted workflow, the candidate adjusted workflow comprising a second vendor, and the candidate adjusted workflow at least minimally satisfying the set of ordered article constraints (see module 1050).

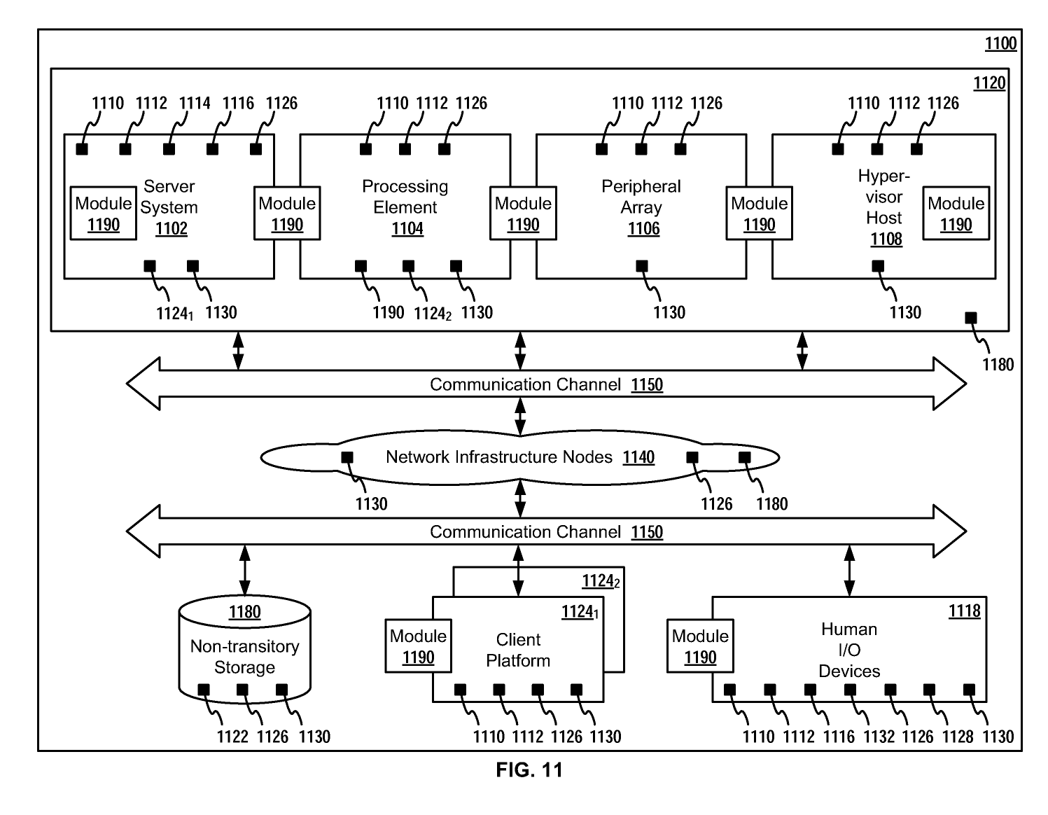

FIG. 11 is a diagrammatic representation of a network 1100, including nodes for client computer systems (e.g. client platform 1124₁ and client platform 1124₂), nodes for server computer systems 1120 in a (e.g. server system 1102, processing element 1104, peripheral array 1106, hypervisor host 1108), and network infrastructure nodes 1140. Any node within network 1100 may comprise a machine within which a set of instructions for causing the machine to perform any of the techniques discussed above may be executed. The embodiment shown is purely exemplary, and any one or more of the nodes of network 1100 might be implemented in the context of one or more of the figures herein. Or, any one or more embodiments as shown in the figures herein might be implemented in the context of network 1100.

Any node of the network 1100 may comprise a processor and memory, a processor being a general-purpose processor, a digital signal processor (DSP), an application-specific integrated circuit (ASIC), a field programmable gate array (FPGA) or other programmable logic device, a discrete gate or transistor logic, discrete hardware components, or any combination thereof capable to perform the functions described herein. A general-purpose processor may be a microprocessor, but in the alternative, the processor may be any conventional processor, controller, microcontroller, arithmetic logic unit (ALU), floating-point unit (FPU), graphics processing unit (GPU), network processing unit (NPU), or state machine. A processor may also be implemented as a combination of computing devices (e.g. a combination of a DSP and a microprocessor, a plurality of microprocessors, one or more microprocessors in combination with a DSP core, or any other such configuration, etc).

In alternative embodiments, a node may comprise a machine in the form of a virtual machine (VM), a virtual server, a virtual client, a virtual desktop, a virtual volume, an embedded computer system, a massively parallel computer system, a cloud computer system, a network router, a network switch, a network bridge, a personal digital assistant (PDA), a smart phone, a mobile terminal, a web appliance, an internet TV, or any machine capable of executing a sequence of instructions that specify actions to be taken by that machine. Any node of the network may communicate cooperatively with another node on the network. In some embodiments, any node of the network may communicate cooperatively with every other node of the network, for example, using the internet, or using a wired or wireless local area network (LAN), or using a storage area network (SAN), or using a personal area network (PAN). Inter-node (or intra-node communication) may be facilitated using a communication protocol (e.g. IPv4, IPv6, TCP/IP, UDP, etc), and the payload of such communication may include any forms of text, audio/video, HTML, HTML5, or any other representation of compressed or uncompressed, or encrypted or unencrypted data).

Any node within network 1100 may include a processor 1110 (e.g. a processor core, a microprocessor, a computing device, etc), and a memory (e.g. main memory 1112). Some embodiments include additional memory (e.g. static memory 1114), a display unit (e.g. computer display 1116), and other computing resources. Any node within network 1100 may execute software, firmware, middleware, operating systems, hypervisor code, microcode or other computer code embodied as a set of instructions 1126.

The sensors and human input/output (I/O) devices 1118 (e.g. a keyboard, an alphanumeric keypad, etc), may include sensors (e.g. accelerometers, gyroscopes, radio receivers, etc) and any forms of human I/O devices such as a pointing device 1132 (e.g. a mouse, a touch screen, a motion transducer, etc), a signal generation device 1128 (e.g. a speaker, an audio output, etc, and/or a display unit), a haptic transducer (with or without bio-feedback), or other devices. A display unit (e.g. computer display 1116) may comprise a touch-screen, or a liquid crystal display (LCD), or a plasma display, or a flat-screen display, or a light emitting diode (LED) display, or a cathode ray tube (CRT).

Any node may include a network interface device 1130 (e.g. an Ethernet interface, a wired network interface, a wireless network interface, a propagated signal interface, etc).

The non-transitory storage 1180 includes embodiments including non-transitory tangible computer readable media using volatile or non-volatile memory. In some cases the non-transitory storage 1180 is embodied within a large scale data management system. In some cases, non-transitory storage 1180 may include a drive unit 1122 for interfacing to a DVD, a Blu-ray disk, a compact disk (CD) or CDROM, a removable media drive (e.g. a DAT or other magnetic tape), a non-volatile storage device (e.g. an SSD, flash drive, spinning media drive, etc), a hard disk drive, or other non-transitory tangible computer readable media for storing instructions. In particular, non-transitory storage 1180 comprises one or more media types on or in which is stored a set of instructions 1126 embodying any one, or all, of the techniques described above. In addition to residing on non-transitory tangible computer readable media, the set of instructions 1126 may reside completely within or at least partially within, main memory 1112 and/or within the processor 1110. The set of instructions 1126 may be transmitted or received via the network interface device 1130 over a communication channel 1150, and/or over network infrastructure nodes 1140.

Module 1190 includes a processor and memory, and module 1190 may be mapped onto or into any node containing a processor and memory. Moreover, a module 1190 may be mapped onto or into a single node (e.g. server system 1102, as shown, or client platform 1124, as shown) or a module 1190 may be mapped onto or into a plurality of nodes (e.g. server system 1102 and processing element 1104, as shown) or onto or into any machine including a processor and memory, and capable of executing a set of instructions 1126.

It is to be understood that embodiments of this invention may be used as, or to support, a set of instructions executed upon some form of a machine having at least one processor and memory, or otherwise implemented or realized upon or within a tangible machine-readable or computer-readable medium. A tangible machine-readable medium includes any mechanism for storing non-transitory information in a form readable by a machine (e.g. a computer). For example, a tangible machine-readable medium includes read-only memory (ROM), random access memory (RAM), magnetic disk storage media, optical storage media, flash memory devices, and electrical, optical or acoustical or any other type of media suitable for storing non-transitory information.

While the invention has been described with reference to numerous specific details, one of ordinary skill in the art will recognize that the invention may be embodied in other specific forms without departing from the spirit of the invention. Thus, one of ordinary skill in the art would understand that the invention is not to be limited by the foregoing illustrative details, but rather is to be defined by the appended claims.

While the invention has been described with reference to numerous specific details, one of ordinary skill in the art will recognize that the invention may be embodied in other specific forms without departing from the spirit of the invention. Thus, one of ordinary skill in the art would understand that the invention is not to be limited by the foregoing illustrative details, but rather is to be defined by the appended claims.

What is claimed is:

1. A computer-implemented method for generating an e-commerce system, comprising:
generating at least one Website from a content management system that allows a user to configure the Website as a dealer Website as part of an alliance that integrates orders processed through a business process management kernel operating on one or more computers, wherein the content management system receives input to configure the dealer Website to offer for sale at least a portion of products or services fulfilled by one or more members of the alliance;
configuring, for at least one product or service, the dealer Website to select a member of the alliance to fulfill orders of the product or service;
configuring, for at least one product or service, the dealer Website to initiate a first-routing of an order through the business process management kernel to the member of the alliance; and
determining, in the business process management kernel, at a time after the first-routing, whether the member of the alliance selected can fulfill the order, and if the member of the alliance selected can't fulfill the order, then initiating a second-routing of the order through the business process management kernel to a different member of the alliance.

2. The computer-implemented method as set forth in claim 1, further comprising:
receiving input, from a consumer computer, on the dealer Website to select for purchase at least one of the products or services;
generating an order for the product or service;
routing, as a first routing, at least a portion of the order to a member of the alliance to fulfill the order; and
routing, as a second routing, at least a portion of the order to a different member of the alliance to fulfill the order if the member of the alliance selected can't fulfill the order.

3. A computer-implemented method as set forth in claim 1, wherein the business process management kernel, as configured, operates to generate a workflow based on business process rules.

4. A computer-implemented method as set forth in claim 3, wherein the workflow comprises selecting at least one member of the alliance based on a quantity constraint, a ship to constraint and a manufacturing capability constraint.

5. A computer-implemented method as set forth in claim 1, wherein the fulfillment comprises at least one of a manufacturing capability, a packaging capability, a shipping capability.

6. A non-transitory tangible computer readable media for generating an e-commerce system, which when executed by the computer, causes the computer to perform the steps of:
generating at least one Website from a content management system that allows a user to configure the Website as a dealer Website as part of an alliance that integrates orders processed through a business process management kernel operating on one or more computers, wherein the content management system receives input to configure the dealer Website to offer for sale at least a portion of products or services fulfilled by one or more members of the alliance;
configuring, for at least one product or service, the dealer Website to select a member of the alliance to fulfill orders of the product or service;
configuring, for at least one product or service, the dealer Website to initiate a first-routing of an order through the business process management kernel to the member of the alliance; and
determining, in the business process management kernel, at a time after the first-routing, whether the member of the alliance selected can fulfill the order, and if the member of the alliance selected can't fulfill the order, then initiating a second-routing of the order through the business process management kernel to a different member of the alliance.

7. The non-transitory tangible computer readable media as set forth in claim 6, further comprising:
receiving input, from a consumer computer, on the dealer Website to select for purchase at least one of the products or services;
generating an order for the product or service;
routing, as a first routing, at least a portion of the order to a member of the alliance to fulfill the order; and
routing, as a second routing, at least a portion of the order to a different member of the alliance to fulfill the order if the member of the alliance selected can't fulfill the order.

8. The non-transitory tangible computer readable media as set forth in claim 6, wherein the business process management kernel, as configured, operates to generate a workflow based on business process rules.

9. The non-transitory tangible computer readable media as set forth in claim 8, wherein the workflow comprises selecting at least one member of the alliance based on a quantity constraint, a ship to constraint and a manufacturing capability constraint.

10. The non-transitory tangible computer readable media as set forth in claim 6, wherein the fulfillment comprises at least one of a manufacturing capability, a packaging capability, a shipping capability.

11. An e-commerce system comprising one or more computers, comprising:
module for generating at least one Website from a content management system that allows a user to configure the Website as a dealer Website as part of an alliance that integrates orders processed through a business process management kernel operating on one or more computers, wherein the content management system receives input to configure the dealer Website to offer for sale at least a portion of products or services fulfilled by one or more members of the alliance;
module for configuring, for at least one product or service, the dealer Website to select a member of the alliance to fulfill orders of the product or service;
module for configuring, for at least one product or service, the dealer Website to initiate a first-routing of an order through the business process management kernel to the member of the alliance; and
module for determining, in the business process management kernel, at a time after the first-routing, whether the member of the alliance selected can fulfill the order, and if the member of the alliance selected can't fulfill the order, then initiating a second-routing of the order through the business process management kernel to a different member of the alliance.

12. The e-commerce system as set forth in claim 11, further comprising:
module for receiving input, from a consumer computer, on the dealer Website to select for purchase at least one of the products or services;
module for generating an order for the product or service;
module for routing, as a first routing, at least a portion of the order to a member of the alliance to fulfill the order; and
module for routing, as a second routing, at least a portion of the order to a different member of the alliance to fulfill the order if the member of the alliance selected can't fulfill the order.

13. The e-commerce system as set forth in claim 11, wherein the business process management kernel, as configured, operates to generate a workflow based on business process rules.

14. The e-commerce system as set forth in claim 13, wherein the workflow comprises selecting at least one member of the alliance based on a quantity constraint, a ship to constraint and a manufacturing capability constraint.

15. The e-commerce system as set forth in claim 11, wherein the fulfillment comprises at least one of a manufacturing capability, a packaging capability, a shipping capability.
